(19) United States
(12) Patent Application Publication
(10) Pub. No.: US 2010/0011791 A1
(43) Pub. Date: Jan. 21, 2010

(54) R422D HEAT TRANSFER SYSTEMS AND R22 SYSTEMS RETROFITTED WITH R422D

(76) Inventors: Roger Nicholas Strickland, Wilmington, DE (US); Calvin Curtis Lawson, Wilmington, DE (US); Neil Andre Roberts, Bristol (GB); James William Dunlap, Hockessin, DE (US); Donald Bernard Bivens, Kennett Square, PA (US); Kevin Patrick O'Shea, Lincoln University, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/520,262

(22) PCT Filed: Dec. 19, 2007
(86) PCT No.: PCT/US07/25958

§ 371 Date: Jun. 19, 2009

Related U.S. Application Data
(60) Provisional application No. 60/871,817, filed on Dec. 23, 2006.
(60) Provisional application No. 60/885,394, filed on Jan. 17, 2007.
(60) Provisional application No. 60/946,511, filed on Jun. 27, 2007.

(51) Int. Cl. F25B 49/02; C09K 5/04; F25B 41/04

(52) U.S. Cl. 62/210; 62/114; 62/115; 62/498; 62/504

(57) ABSTRACT

A heat transfer system capable of being coupled to
at least one temperature controlled zone, the elements of the system comprising:
(i) at least one liquid refrigerant line;
(ii) at least one expansion valve selected for R22 or R422D;
(iii) at least one evaporator
(iv) at least one compressor;
(v) at least one condenser;
(vi) at least one vapor refrigerant line; and wherein all of the elements have an inlet side and an outlet side and elements (i) through (vi) are in fluid communication together and contains R422D; and the system further comprising a sensing element communicatively coupled to the outlet side of at least one evaporator and at least one expansion valve and at least one sensing element contains a fluid selected to work when R22 is in the condenser-to-evaporator circuit, or R422D. Further disclosed are methods for retrofitting R22 containing heat transfer systems, including refrigerators and air conditioners. Also disclosed are refrigerators and air conditioners containing only R422D.

### FIELD OF INVENTION

This invention relates to heat transfer systems capable of utilizing a refrigerant known as R422D, as well as systems utilizing both chlorodifuoromethane (hereafter referred to as “R22”), an expansion valve, and a refrigerant known as R422D, which is a refrigerant comprising 1,1,1,2-tetrafluoroethane, pentafluoroethane and isobutane.

### BACKGROUND OF THE INVENTION

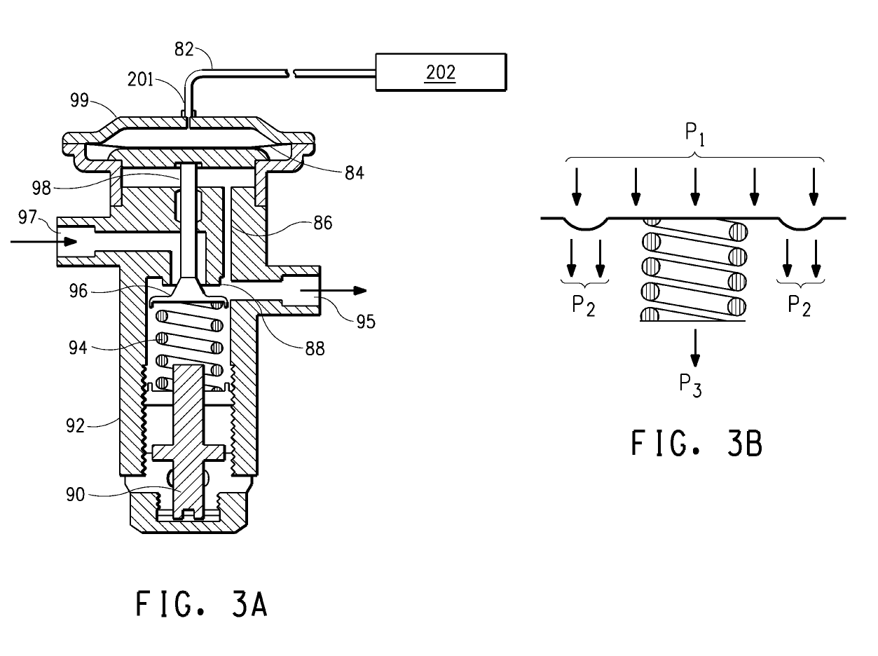

Many heat transfer systems (such as refrigerators, freezers, and air conditioning systems) use thermostatic expansion valves (one example is shown in the schematic in FIG. 3). In such systems, the valves have long been used to release refrigerant into the evaporator in a controlled manner. Indeed, expansion valves are an important part of commercial refrigeration and air conditioning equipment. In some situations, such expansion valves can be a limiting factor in the capacity and reliability of the heat transfer system.

Many such expansion valves operate by having three forces or pressures controlling the release of liquid refrigerant into the evaporator at a constant enthalpy causing a partial phase change of the refrigerant to a liquid/gas (two phase flow). The two phase refrigerant then enters the evaporator. (See, e.g., FIG. 3) The first of these is pressure P1, which is the pressure generated from the thermostatic element's vapor pressure (as acted upon by the sensing element). P1 acts as an opening force to allow refrigerant to flow to the evaporator. The second pressure P2 is the pressure of the evaporator that acts as a closing force for the valve. The third pressure P3 is the spring force of the particular valve sized appropriately to enable the evaporator to maintain the evaporator target temperature, remove the heat load, and to maintain the desired superheat of the refrigerant vapor exiting the evaporator.

The expansion valves, with its spring, are selected to work with a particular system in mind. Selection of the proper expansion valve often requires, among other factors, consideration of the refrigerant utilized, the designed cooling capacity of the system, as well as the actual cooling load. In the end, the expansion valve is selected so as to create a stable operating system wherein the three forces are appropriately balanced to enable the expansion valve to control the evaporator temperature and the superheat of the refrigerant vapor.

Currently, many refrigeration and air conditioning systems use R22 in both the sensing element coupled to the expansion valve, and as well as the “condenser-to-evaporator circuit” of the refrigeration and air conditioning systems. The term “condenser-to-evaporator circuit” is a term used to describe that portion of a heat transfer system that includes all of the system elements and components in fluid communication together from the condenser to the expansion valve to the evaporator and all conduits and other elements that may be in fluid communication between the expansion valve and the evaporator. However, the term “condenser-to-evaporator circuit” excludes the sensing element.

There is a strong desire to replace R22 in the condenser-to-evaporator circuit of the refrigeration and air conditioning systems. While replacement refrigerants, based on the cooling capacity, are known for R22, replacing refrigerants for existing systems currently requires retrofitting the system with a different (and often newly selected or newly designed) expansion valve to accommodate the different physical and thermodynamic properties of the replacement refrigerant. In addition to the cost of a replacement expansion valve, to retrofit a system for a different expansion valve requires taking the system out of use for the length of time necessary to remove/replace contents of the temperature control zone, install the newly selected valve, and test (and correct any problems if necessary) the retrofitted system. Consequently, there is a need to have a heat transfer system that can continue to use R22, or a fluid selected to be used when R22 is in the condenser to evaporator circuit, in a sensing element coupled to an R22 expansion valve when such R22 sensing element is coupled to the evaporator having the replacement refrigerant, preferably a non-ozone depleting refrigerant in the evaporator of such systems.

### DESCRIPTION

Described herein is a heat transfer system capable of being coupled to at least one temperature controlled zone, the elements of the system comprising:
(i) at least one liquid refrigerant line;
(ii) at least one expansion valve (where in some embodiments the expansion valve is selected for R22 refrigerant and in other embodiments, the expansion valve is selected for R422D, which is more fully described below;
(iii) at least one evaporator;
(iv) at least one compressor;
(v) at least one condenser; and
(vi) at least one vapor refrigerant line; and wherein all of the elements (i) through (vi) have an inlet side and an outlet side, and the elements (i) through (vi) are in fluid communication together and contain R422D refrigerant; and the system further comprising a sensing element having two ends; wherein one end is communicatively coupled to outlet side of at least one evaporator and the other end is communicatively coupled to at least one expansion valve. In some embodiments, at least one sensing element contains a fluid suitable for use when R22 is in the condenser-to-evaporator circuit, and in other embodiments, at least one sensing element contains R422D.

R422D is a composition selected from possible compositions having the following components (herein after referred to herein as “R422D”):

(1) 64-66% by weight of pentafluoroethane (R-125, CF₃CHF₂, normal boiling point of −48.5° C.);

(2) 30.5-32.5% by weight of 1,1,1,2 tetrafluoroethane (R-134a, CH₂FCF₃ normal boiling point of −26° C.), and (3) (3) 3.0-3.5% isobutane (R600a, CH(CH₃)₃, normal boiling point of −11.8° C.).

At refrigeration cycle conditions of 100 degrees F. average condenser temperature and 20 degrees F. average evaporator temperature, R422D evaporator dew point vapor pressure is about 43 psig.

Moreover, in some embodiments, the R422D composition has at least 90% the cooling capacity of R22 in systems operated under the following conditions: having no more than 10 degrees of subcooling and an average −25 degree F. evaporator. In other embodiments, R422D has more than 90% of the cooling capacity of R22 in systems operated under the following condition: having at least 10 degrees of subcooling and an average 20 degree F. evaporator.

In other embodiments, R422D has more than 90% of the cooling capacity of R22 in systems operated under the following conditions: having no more than 10 degrees of subcooling and an average 20 degree F. evaporator.

In some embodiments, the R422D has between 95 and 108% of the cooling capacity of R22. In some embodiments, the compressor's injection cooling is disabled and the R422D has about 106% cooling capacity of R22.

Moreover, R422D compositions have an ozone depletion potential of zero.

In some embodiments, substantially pure R22 is used in the sensing element. In other embodiments, the R22 in the sensing element may have additional additives. In some embodiments, there may be impurities acquired during use of the composition in the sensing line. In some embodiments the additives include those described below. In some embodiments of a sensing element, the fluid suitable for use in the sensing element, when R22 is used in the condenser-to-evaporator circuit, is a fluid or fluid mixture which has a pressure equal to or higher than R22. In some embodiments of a sensing element, the fluid suitable for use in the sensing element when R22 is used in the condenser-to-evaporator circuit, is a fluid or fluid mixture which has a pressure equal to or lower than R22. In some embodiments, wherein the fluid in the at least one sensing element is a fluid or fluid mixture selected to work when R22 is in the condenser-to-evaporator circuit, and having a slope of pressure/temperature relation that is substantially different from that of R22.

In some embodiments, substantially pure R422D is used in the condenser-to-evaporator circuit.

In some embodiments, R22 is used in at least one sensing element and a R422D composition is used in the condenser-to-evaporator circuit. In some embodiments, a R422D composition is used in the sensing element and a R422D composition is used in the condenser-to-evaporator circuit.

Additives that may optionally be added to either the R22 or a R422D composition (or both) include additives such as lubricants, corrosion inhibitors, surfactants, anti-foam agents (e.g., Dow 200), solvents (e.g., Exxon's Isopar H) stabilizers, oil return agents (including polymeric oil return agents), dyes and other appropriate materials may be added to the described compositions.

In some embodiments, the lubricants added to the R422D and/or R22 are selected from polyalkylene glycols, polyol esters, mineral oils, alkylbenzene and mixtures thereof.

In some embodiments, the R22 or R422D compositions may further include one or more additives in an amount of up to 10% by weight of the compositions. In other embodiments, one or more additives are present in the above described compositions in an amount of less than 500 ppm in the composition. In other embodiments, one or more additives are present in the above described compositions in an amount of less than 250 ppm in the composition. In other embodiments, one or more additives are present in the above described compositions in an amount of less than 200 ppm in the composition.

In other embodiments, one or more additives may be in the composition in an amount of from 0.1 to 3% weight. In other embodiments, one or more additives may be in the composition in an amount of from 0.1 to 1.5% weight.

In some embodiments, the described compositions optionally contain from about 1% to about 60% by weight of polyalkylene glycols, polyol esters, mineral oil, alkylbenzene or mixtures thereof as lubricants. In some embodiments the described compositions optionally contain from about 10% to about 50% by weight of polyalkylene glycols, polyol esters, mineral oil, alkylbenzene or mixtures thereof as lubricants.

In addition, in some embodiments, polymeric oil return agents such as Zonyl®PHS (which may be purchased from the E.I. du Pont de Nemours and Company), which aid in solubilizing or dispersing mineral or synthetic lubricants may be added.

For purposes of the heat transfer systems described herein, the following definitions are used to define the terms.

A Temperature Controlled Zone means a space that is utilized to transfer, move, or remove heat from one space, location, object or body to a different space, location, object or body by radiation, conduction or convection and combinations thereof. For example, in some embodiments, the temperature-controlled zone is a case, cabinet, room, enclosure or semi-enclosure. The temperature of such temperature controlled zones can have temperatures typical of a cooler, freezer, chiller, or a refrigerator. In some embodiments, a temperature controlled zone can be a room or office cooled by an air conditioner, or dehumidifier or heat pump, or combination thereof.

In some embodiments, the Temperature Controlled Zone is selected from a refrigerator case, freezer case, cabinet, drink chiller, wine chiller, deli case, bakery case, produce display case and combinations thereof. In some embodiments, the produce display case has a water mister and in other embodiments the produce display case does not have a water mister. In some embodiments, the Temperature Controlled Zone, is a room, warehouse, laboratory, industrial manufacturing area (e.g., for computer equipment or chemical reactions) or simply a confined space (for example, a large tent having cooled or heated air inside) and combinations thereof.

In some embodiments, the temperature controlled zone is a case, room, chamber, or a cabinet having at least one door that may open from the top (such a freezer case). In some embodiments, the case, room, chamber, or a cabinet. In some embodiments, the temperature controlled zone has at least one door that opens from one or more of its sides, including by one or more doors (such as a supermarket or convenient store display cases having multiple doors). In some embodiments, there are more than one temperature controlled zones in the system. In some embodiments, the multiple temperature controlled zones have the same or different target temperatures.

As used herein, mobile refrigeration apparatus or mobile air-conditioning apparatus refers to any refrigeration or air-conditioning apparatus incorporated into a transportation unit for the road, rail, sea or air. In addition, apparatus, which are meant to provide refrigeration or air-conditioning for a system independent of any moving carrier, known as “intermodal” systems, are included in the present invention. Such intermodal systems include “containers” (combined sea/land transport) as well as “swap bodies” (combined road and rail transport). The compositions as disclosed herein may be useful in mobile applications including train passenger compartment air-conditioning, transport air-conditioning or refrigeration, rapid transport (subway) and bus air-conditioning.

The term “target” is a term used to describe a goal or a set point. The term is used in view of the fact that, when a system is in operation, the actual temperature of system components, such as the temperature controlled zones, the evaporators, or compressors, may vary over time for any number of reasons, including power outages, equipment malfunctions, start up and shut down procedures, defrost cycles, the amount and temperature of the contents placed in such temperature controlled zone at any time and combinations thereof.

Subcooling is a term used to define how far below its saturation liquid temperature a liquid composition is cooled.

Superheat is a term used to define how far above its saturation vapor temperature a vapor composition is heated.

Static superheat is a term used to define the amount of superheat required to open the expansion valve to allow liquid refrigerant to flow past the valve plug.

Capacity is a term used to describe the amount of heat that can be transferred, moved, removed, or rejected over time. One unit of measure of capacity is the number of British Thermal Units (“BTU”) per hour. 12,000 BTU/hour is also defined as 1 Ton of heating or cooling capacity.

Condenser is a term used to define the component of a system that condenses the vapor refrigerant to a liquid refrigerant. In some embodiments, at least one condenser is located remotely from at least one evaporator; in other embodiments, the distance between a condenser and an evaporator is at least 15 feet; in other embodiments, the distance is more than 50 feet.

A Compressor is a mechanical device that increases the pressure of a vapor by reducing its volume. Compression of a vapor naturally increases its temperature. In some embodiments, there are more than two compressors. In some embodiments with more than two compressors, the compressors are not of the same type.

In some embodiments, the compressor utilizes an injection cooling feature. Injection cooling is a system that diverts some portion of the condensed refrigerant leaving the condenser back to the compressor to prevent overheating. In some embodiments, overheating of the compressor may lead to oil degradation that may ultimately result in early compressor failure (shorter compressor life). Some systems that utilize injection cooling lose cooling capacity and energy efficiency because not all the refrigerant compressed is going to the evaporator to provide the cooling of the temperature controlled zone.

There are many types of compressors useful in heat transfer systems described herein, and some embodiments may have one or more compressor. In some embodiments, the compressors may have the same power rating or different power ratings. In some embodiments, there are more than two compressors. In some embodiments with more than two compressors, the compressors are not of the same type. In some embodiments, a compressor can be hermetic or semi-hermetic.

In some embodiments, at least one compressor is located remotely from the condenser; in some embodiments, this distance is at least 15 feet; and in other embodiments, this distance is at least 50 feet.

In some embodiments, the individual compressors have a power capacity of from ⅕ horse power (“hp”) to up to 500 horse power. In some embodiments, at least one compressor has a power capacity of from ⅕ hp to up to 50 hp. In some embodiments the systems have 5 or more compressors.

In some embodiments, the system has at least one compressor having a power rating of from 5 to 30 horse power. In some embodiments, the system has at least two compressors, each having a power rating of from 5 to 30 horse power. In some embodiments, the system has at least three compressors, each having a power rating of from 5 to 30 horse power. In some embodiments, the system has at least four compressors, each having a power rating of from 5 to 30 horse power. In some embodiments, the system has at least five compressors, each having a power rating of from 5 to 30 horse power.

In some embodiments, the type of compressor is selected from those including, but not limited to, those described below.

Reciprocating compressors use pistons driven by a crankshaft. They can be either stationary or portable, can be single or multi-staged. In some embodiments, such reciprocating compressors are driven by electric motors or internal combustion engines. In some embodiments, reciprocating compressors have the power that can be from ⅕ to 30 horsepower (hp). In other embodiments, the reciprocating compressors may have 50 hp. In some embodiments, the compressors are able to handle discharge pressures from low pressure to very high pressure (e.g., >5000 psi or 35 MPa).

Rotary screw compressors use two meshed rotating positive-displacement helical screws to force the gas into a smaller space. In some embodiments, rotary screw compressors can be from ⅕ hp (3.7 kW) to over 500 hp (375 kW) and from low pressure to very high pressure (e.g., >1200 psi or 8.3 MPa).

Scroll compressors, which are in some ways similar to a rotary screw device, include two interleaved spiral-shaped scrolls to compress the gas. Some scroll compressors can be from ⅕ hp (3.7 kW) to over 500 hp (375 kW) and from low pressure to very high pressure (e.g., >1200 psi or 8.3 MPa).

Centrifugal compressors belong to a family of turbomachines that include fans, propellers, and turbines. These machines continuously exchange angular momentum between a rotating mechanical element and a steadily flowing fluid. The fluid vapor is fed into a housing near the center of the compressor, and a disk with radial blades (impellers) spins rapidly to force vapor toward the outside diameter. The change in diameter through the impeller increases gas flow velocity, which is converted to a static pressure increase. A centrifugal compressor can be single-stage, having only one impeller, or it can be multistage having two or more impellers mounted in the same casing. For process refrigeration, a compressor can have as many as 20 stages.

In some embodiments, systems can have the compressor capacity as low as 1000 BTU/hour or as high a One Million BTU/hour.

In other embodiments, the compressor capacity of the system is up to 10,000 BTU/hour. In other embodiments, the compressor has the capacity of the system as high as 600,000 BTU per hour or higher.

Suitable compressors can be purchased from any number of equipment manufacturers, such as Carlyle, Copeland, and Bitzer to name several.

An Evaporator is the heat absorption component of a system where the liquid heat transfer composition (e.g., refrigerant) is evaporated from a liquid to a vapor. Evaporators have at least one inlet port for receiving liquid refrigerant compositions and at least one outlet port where by refrigerant in the vapor phase is exhausted. The evaporator outlet port is in fluid communication to at least one or more compressors.

In some embodiments, an evaporator has one or more coils. In some embodiments, an evaporator has three or more coils. In some embodiments, an evaporator has five or more coils. In some embodiments, an evaporator has eight or more coils. In some embodiments, an evaporator has no coil. The evaporator coil is inside of the evaporator and in some embodiments, the coil is the conduit through which two phase liquid/vapor refrigerant moves and is evaporated to the vapor state. In some embodiments, the size of the evaporator coil is ¼″ diameter or smaller. In some embodiments, the size of the evaporator coil is larger than ¼″ diameter. In some embodiments, the size of the evaporator coil can be up to 2″ in diameter. In some embodiments, the size of the evaporator coil can be up to 6″ in diameter. In some embodiments the size of the evaporator coil can be up to 12″ in diameter.

In some embodiments, an evaporator is a single cavity. In some embodiments, air is moved over the evaporator coil(s) or single cavity and is the heat transfer medium that transfers heat to or from the temperature controlled zone.

In some embodiments, there may be two or more different sizes of evaporators in the system. And in some systems with two or more evaporators, some systems can have evaporators that are identical. In other multi-evaporator systems, the evaporators are not identical. In some multi-evaporator systems, each evaporator can have the same or a different number of coils.

In the embodiments described herein, the system contains an R422D composition in the condenser-to-evaporator circuit.

In some embodiments, the evaporator coils extend to a distance outside of the evaporator and, as such, are capable of being in fluid communication to a distributor at the distributor's outlet port(s). In some embodiments, the length of the evaporator coil(s) extending outside of an evaporator is a length selected from the lengths of about 12 inches, about 18 inches, about 24 inches, about 30 inches, about 36 inches, about 42, inches, about 48 inches, about 54 inches, about 60 inches, about 66 inches, or about 72 inches and combination thereof.

An Expansion Valve is one type of metering device which controls the flow of refrigerant between the condenser and the evaporator in a heat transfer system. Such expansion valves may be automatic valves or thermostatic valves. Liquid refrigerant flows into the Expansion Valve where it becomes two phases (liquid and vapor phases). The two phase refrigerant exits the expansion valve and flows into the evaporator. See FIG. 3 which is a schematic illustrating one type of an expansion valve. An expansion valve may include other elements and be coupled with a temperature responsive sensor that communicates with a diaphragm or bellows in the expansion valve body. In a system used for cooling, the expansion valve functions to throttle liquid from the high-pressure condenser pressure to the low-pressure evaporator pressure, while feeding enough refrigerant to the evaporator to have effective heat removal and superheat control.

The expansion valve is used to avoid over feeding the evaporator, and thusly, useful to help in preventing liquid refrigerant from reaching the compressor(s) of the system. The expansion valve(s) of any system are selected to work in system having a predetermined amount of superheat at the outlet of the evaporator. The amount of superheat is one aid in avoiding liquid refrigerant from reaching the compressor(s) of the system.

Expansion valves are often selected based a number of factors relating to the system's utility and can vary from system to system as well as within each system. Expansion valves are also sized and selected with the thermo-physical properties of a particular heat transfer composition (e.g., R22 or a R422D composition) to be used in the system.

Other factors useful in selecting an expansion valve may include the rated load of the system, the evaporator's target average operating temperature as well as the target temperature to be maintained in the temperature controlled zone.

In some embodiments, the expansion valve is a thermostatic expansion valve (herein referred to as a “TXV”), of which one embodiment is illustrated in FIG. 3. In some embodiments, the TXVs useful in the described systems herein, have a capacity of up to 0.25 Ton; in some embodiments, a TXV has up to a 0.5 Ton capacity; in other embodiments, a TXV has up to a 3 Ton capacity; and in still other embodiments, the TXV can have a capacity higher than 3 Tons. In some embodiments, there is more than one TXV; in some embodiments, the TXVs have the same capacity; and in other embodiments, the TXVs may have different capacities.

In some embodiments, the system may further include a check valve which when the refrigerant flows in the reverse direction (such as with a heat pump type system), the check-valve opens to allow refrigerant to bypass the expansion valve. In some systems, the expansion valve may be a self-contained combination temperature and pressure responsive thermostatic expansion valve and check valve (see, e.g., U.S. Pat. No. 5,524,819).

In some of the system embodiments described herein, the expansion valves are selected for use with R22 refrigerant. In other embodiments, the expansion valves are selected for use with a R422D composition. In some embodiments, the expansion valves are expansion valves already in use in existing heat transfer systems using R22 in the condenser-to-evaporator circuit and R22, or a fluid or fluid mixture selected to provide appropriate control to the expansion valve when R22 is used in the condenser-to-evaporator circuit, in the existing sensing element. In some embodiments, the sensing element provides appropriate control to the expansion valve whereby, as the temperature of the refrigerant exiting the evaporator increases or decreases, the temperature of the fluid in the sensing element likewise increases or decreases. As the temperature of the fluid increases, the pressure in the sensing line increases. As the temperature of the fluid decreases, the pressure in the sensing line decreases.

In some embodiments, a group of elements illustrated in FIG. 3 are referred to as a Powerhead. In one such embodiment, a Powerhead would comprise a diaphragm, 84, a thermostatic element, 99, a capillary tube, 82, a sensing element, 201, and a remote bulb, 202.

In some embodiments, the expansion valves are designed to work with or otherwise accommodate a distributor. In some embodiments, the distributor may include a distributor nozzle. The nozzle on the distributor reduces the outlet port size from the expansion valve. In some embodiments the nozzle reduces the outlet port from the TXV by as much as 75%. In other embodiments, the nozzle reduces the TXV outlet port by at least 50%. In other embodiments the TXV outlet port is reduced by at least 30%. In other embodiments the TXV outlet port is reduced by less than 30%. In other embodiments, the nozzle reduces the outlet port of the TXV and is sized to achieve sufficient turbulence to create a substantially uniform mixture of a two-phase liquid and vapor refrigerant that will enter the evaporator.

In some system embodiments, one or more expansion valves may further have an external equalizer coupled to the outlet side of the evaporator and the bottom of the diaphragm or bellows of the thermostatic expansion valve. In some embodiments, the external equalizer is used in systems having a high pressure drop across the evaporator's inlet and outlet or where an expansion valve distributor is required. In some embodiments a TXV is used with an external equalizer.

When an external equalizer is used, an equalizer fitting (having two ends) is connect to the evaporator outlet port at one end and connected to the expansion valve's diaphragm (or bellows as the case may be) allowing R422D vapor to fill the external equalizer and apply the R422D vapor pressure (P2 of FIG. 3) to the diaphragm (or bellows as the case may be).

A distributor is an apparatus in fluid communication with at least one expansion valve. The use of a distributor on an expansion valve can increase the pressure drop in a large evaporator by providing several parallel paths through the evaporator (e.g., an evaporator having multiple coils).

In some embodiments, distributors are used in systems having refrigerated display cases, walk-in coolers, freezers and combinations thereof (for example, such as systems often found in supermarkets and convenience stores). In some embodiments, the distributor can have two or more outlet ports; in some embodiments, the distributor has three or more outlet ports; and in other embodiments, the distributor has at least six outlet ports. In other embodiments, the distributor has more than six outlet ports.

In some embodiments, the distributor outlet ports have an outside diameter ranging from diameters selected from dimensions in the range of from about 3/16 inches to about ⅜ inches. In some embodiments, the outside diameter of the distributor port is more than ⅜ inches.

In some embodiments, the nozzle and the distributor are separate elements, and in other embodiments, the nozzle and distributor are a single element.

Sporlan, Emerson Flow and Danfoss are a few of the manufacturers and suppliers of expansion valves, nozzles and distributors.

The expansion valve, nozzle and distributor are typically selected and sized to fit the heat load of the system and the evaporator to which it will be coupled. In some systems, having more than one expansion valve, each expansion valve may be the same or different; and each may have the same or different nozzle and/or distributor; and each distributor may have the same or different number of distributor outlet ports; and each distributor outlet port may be the same or different.

In some systems, there are an equal number of expansion valves and evaporators. In other systems, there are more evaporators than expansion valves. In some systems not all TXVs have a distributor coupled to it.

The high pressure side is the side of refrigeration system where the condensing of vapor refrigerant takes place.

A Liquid Refrigerant Line is the term used to describe all of the conduits used to deliver liquid R422D refrigerant to the expansion valve(s). In some embodiments there can be more than one type of liquid refrigerant lines.

The conduit sizes of a liquid refrigerant lines can vary and will depend on, among other factors, the size of the system, the capacity of evaporators in fluid communication with each liquid refrigerant line, as well as where in the system that portion of the liquid refrigerant line is being used. In some embodiments, the Liquid Refrigerant Line may have a diameter of ¼″ or smaller. In some embodiments, the Liquid Refrigerant Line may have a diameter of larger than ¼″. In some embodiments, the Liquid Refrigerant Line can have a diameter of up to 2″. In some embodiments, the Liquid Refrigerant Line can have a diameter of up to 6″. In some embodiments, the Liquid Refrigerant Line can have a diameter of up to 12″.

In some embodiments, the Liquid Refrigerant Line may further comprise a Liquid Circuit Line, a Liquid Trunk Line or combinations thereof. In some embodiments, the liquid refrigerant line comprises of one or more liquid circuit lines, one or more trunk lines or combinations thereof.

In some embodiments, the liquid refrigerant line is about 5 feet in length. In some embodiments, the liquid refrigerant line is between about 5 and 10 feet in length. In some embodiments, the liquid refrigerant line is longer than 10 feet in length. The liquid refrigerant lines can have the same length and the same diameter or different lengths and different diameters.

A Liquid Circuit Line is one type of the Liquid Refrigerant Line and is a term used to describe that portion of the liquid refrigerant line in fluid communication to the expansion valve and is a conduit where liquid refrigerant flows from the condenser to the expansion valve. The liquid circuit line conduit size can vary and can depend on, among other factors, the size of the system as well as the capacity of evaporators in fluid communication with each liquid circuit line.

In some embodiments, there are two or more evaporators in fluid communication with the same liquid circuit line. In some embodiments the liquid circuit line may be 5 feet or shorter. In some embodiments, the liquid circuit line may be from about 5 to 10 feet in length. In some embodiments, the liquid circuit line may be longer than 10 feet in length. In some embodiments, the liquid circuit line may be as long as 20 feet. In some embodiments, the liquid circuit line is longer than 20 feet in length. In some embodiments, there are two or more liquid circuit lines, which can have the same or different lengths. The liquid circuit lines can have the same length and the same diameter or different lengths and different diameters.

A Liquid Trunk Line is a type of liquid refrigerant line and is the term used to define a portion of the liquid refrigerant line in system embodiments having more than one liquid circuit line. The Liquid Trunk Line is a conduit carrying liquid refrigerant from the condenser to the liquid circuit lines.

In some embodiments, the Liquid Trunk Line is 20 feet or shorter. In some embodiments, the Liquid Trunk Line is longer than 20 feet. In some embodiments, the Liquid Trunk Line may be as long as 30 feet. In some embodiments, the Liquid Trunk Line may be as long as 50 feet. In some embodiments, the Liquid Trunk Line may be as long as 100 feet. In some embodiments, the Liquid Trunk Line is more than 100 feet. In some embodiments, the Liquid Trunk Line is more than 200 feet. In some embodiments, the Liquid Trunk Line is more than 300 feet. In some embodiments, the Liquid Trunk Line is more than 500 feet. In some embodiments, the Liquid Trunk Line is more than 1,000 feet. In some embodiments, the Liquid Trunk Line is more than 1,500 feet. In some embodiments, the Liquid Trunk Line is more than 2,000 feet. In some embodiments, there are two or more Liquid Trunk Lines that can have the same length or different lengths. The liquid trunk lines can have the same length and the same diameter or different lengths and different diameters.

In some embodiments, there are two or more liquid circuit lines in fluid communication with at least one liquid trunk line, which is, in turn, in fluid communication with the outlet side of the condenser. In some embodiments, there may be more than one liquid trunk line and more than one condenser. In some embodiments, there is more than one liquid trunk line in fluid communication with one condenser.

In some embodiments, the systems further have one or more oil separators. The oil separator is a term used to refer to any apparatus that separates all or a portion of any oil picked up by the circulating R422D in the compressor during the compression cycle. In some embodiments, the oil separator stores the oil; and in other embodiments, the oil separator returns the oil to the compressor. In some embodiments, the oil separator stores the oil and returns the oil to the compressor. In some embodiments, the oil separator is located near the outlet side of the compressor

In some embodiments, there is a subcooler. A Subcooler is a term used to describe any element of the system that cools the liquid refrigerant before it reaches the liquid refrigerant metering device (e.g., TXV). A subcooler can be as simple as extra piping or conduit or a separate apparatus, such as a heat exchanger using a cooling medium, such as chilled water or refrigerant, to cool the liquid refrigerant prior to it reaching the expansion valve. In some embodiments, the piping or conduit is about three feet in length. In some embodiments, the subcooler feature comprising piping or conduit is longer than 3 feet. In some embodiments, subcooler feature comprises a length of pipe or conduit which is not insulated.

In such embodiments, the piping or conduit is selected from the group consisting of copper, copper alloys (including alloys containing molybdenum and nickel), aluminum or aluminum alloys, or stainless steel or combination thereof. In some embodiments, subcooling is accomplished by placing the liquid refrigerant lines from at least two systems adjacent to each other, wherein at least two liquid refrigerants are at two different temperatures. In one embodiment, the subcooler is created by positioning a length of the liquid refrigerant line from a low temperature system near a length of length of the liquid refrigerant line from a medium temperature system. In some embodiments, the liquid refrigerant lines are adjacent to each other over a substantial distance.

In some embodiments, the two different temperature liquid refrigerant lines can be substantially straight. In other embodiments, the two different temperature liquid refrigerant lines can be curved. In still other embodiments, two different temperature liquid refrigerant lines can include a loop. In some embodiments, the subcooling may be accomplished by a separate cooling apparatus using a refrigerant used alone or in combination with other subcooler elements.

In some embodiments, more than one element contributes to subcooling the liquid refrigerant.

In some embodiments, the system may also have a liquid refrigerant receiver in fluid communication between the condenser and the evaporator. In some embodiments, the liquid refrigerant receiver is placed prior to the TXV. A receiver is a term used to refer to any system element that can hold liquid refrigerant for any number of reasons. Such reasons include creating a reservoir of liquid refrigerant from which the expansion valve can draw, a collection apparatus useful for storing liquid refrigerant during system maintenance operation, as well as other needs that any individual system may have and combinations of reasons and combinations of reasons.

In some embodiments, there is more than one receiver. In some embodiments, there is at least one subcooler and at least one receiver placed in the system after the condenser and prior to the evaporator.

In some embodiments, the liquid trunk line is in fluid communication with the liquid refrigerant receiver. In some embodiments, the liquid refrigerant receiver is any container of any shape (including, but not limited to, for example, a conduit having a larger diameter than the liquid trunk line, or bowl, tank, drum, canister, and the like). The liquid refrigerant receiver can be made of any material suitable for holding the R422D, including but not limited to copper, copper alloys, aluminum, aluminum alloys, stainless steel, or combinations thereof. In some copper alloy embodiments, the copper alloy further contains molybdenum and nickel and mixtures thereof.

In some embodiments, the receiver is a tube shape with a diameter of between about 6 and about 15 inches and a length of from about 50 to about 250 inches. In other embodiments, the receiver may have a diameter of between about 12 and about 13 inches and a length of from about 100 to about 150 inches. In one embodiment, the receiver has a diameter of about 12.75 inches and a length of about 148 inches. In another embodiment, the receiver has a diameter of about 12.75 inches and a length of about 104 inches. In some systems there are two or more receivers, which can be placed near each other in the system or in different locations in the system. In some embodiments, the receiver is sized to hold the entirety of the refrigerant charge. In some embodiments, the receiver has a volume of 0.1 cu. ft. or less. In some embodiments, the receiver has a volume of larger than 0.1 cu. ft. In some embodiments, the receiver has a volume of up to 1 cu. ft. In some embodiments, the receiver has a volume of up to 10 cu. ft. In some embodiments, the receiver has a volume of up to 50 cu. ft. In some embodiments, the receiver has a volume larger than 50 cu. ft.

A Vapor Refrigerant Line is a term used to describe the conduit(s) which delivers vapor refrigerant from the evaporator to the condenser. In some embodiments, the vapor refrigerant line comprises one or more vapor circuit lines, one or more suction line or combinations thereof. The conduit size of any vapor refrigerant line can vary and will depend on the size of the system as well as the capacity of evaporators in fluid communication with each liquid circuit line, as well as where in the system that portion of the conduit is being used. In some embodiments, the vapor circuit line is 5 feet in length, and in other embodiments the vapor circuit line is 10 feet in length. In some embodiments, the vapor refrigerant lines have the same length or different lengths and may have the same or different diameters. In some embodiments, the Vapor Refrigerant Line can have a diameter of ¼″ or smaller. In some embodiments, the Vapor Refrigerant Line can have a diameter of larger than ¼″. In some embodiments, the Vapor Refrigerant Line can have a diameter of up to 2″. In some embodiments, the Vapor Refrigerant Line can have a diameter of up to 4″. In some embodiments, the Vapor Refrigerant Line can have a diameter of up to 6″. In some embodiments, the Vapor Refrigerant Line can have a diameter of up to 12″. In some embodiments, the Vapor Refrigerant Line can have a diameter up to 24″. In some embodiments, the Vapor Refrigerant Line can have a diameter larger than 24″.

In some embodiments, there may be a Vapor Circuit Line. A Vapor Circuit Line is a term used to describe a portion of the Vapor Refrigerant Line and in fluid communication with the evaporator outlet and the Suction Line. In some embodiments the vapor circuit Line may be 5 feet or shorter. In some embodiments, the vapor circuit line may be from 5 to 10 feet in length. In some embodiments, the vapor circuit line may be as long as 20 feet. In some embodiments, there are two or more vapor circuit lines, which can have the same or different lengths and may have the same or different diameters.

A Suction Line is a term used to describe a portion of the Vapor Refrigerant Line that is in fluid communication with the evaporator outlet and the compressor inlet. In some embodiments, the Suction Line is 20 feet or shorter. In some embodiments, the Suction Line is longer than 20 feet. In some embodiments, the Suction Line may be as long as 30 feet. In some embodiments, the Suction Line may be as long as 50 feet. In some embodiments, the Suction Line may be as long as 100 feet. In some embodiments, the Suction Line is more than 100 feet. In some embodiments, the Suction Line is more than 200 feet. In some embodiments, the Suction Line is more than 300 feet. In some embodiments, the Suction Line is more than 500 feet. In some embodiments, the Suction Line is more than 1,000 feet. In some embodiments, the Suction Line is more than 1,500 feet. In some embodiments, the Suction Line is more than 2,000 feet. In some embodiments, there are two or more Suction Lines that can have the same length or different lengths and may have the same or different diameters.

In some embodiments, the suction line is in fluid communication with more than one compressor and in other embodiments, there is more than one suction line in fluid communication with one compressor.

The suction pressure is the pressure on the low pressure side of the system.

A Sensing Element is a device having two ends: one end is communicatively coupled to the outlet side of at least one evaporator and senses the temperature of the vapor exiting the evaporator, and the other end is communicatively coupled to at least one pressure sensing element of the expansion valve. The sensing element contains refrigerant or other fluid, and the refrigerant or other fluid in the sensing element is sealed from the R422D refrigerant circulating in the condenser-to-evaporator circuit such that there is no co-mingling of components.

In some embodiments described herein, the sensing element contains a fluid suitable for use when R22 is used in the condenser-to evaporator circuit. In some embodiments, at least one sensing element contains a R422D composition. In some embodiments of a sensing element, the fluid suitable for use in the sensing element when R22 is used in the condenser-to-evaporator circuit is R22. In some embodiments of a sensing element, the fluid suitable for use in the sensing element, when R22 is used in the condenser-to-evaporator circuit, is a fluid or fluid mixture which has a pressure equal to or higher than R22. In some embodiments of a sensing element, the fluid suitable for use in the sensing element when R22 is used in the condenser-to-evaporator circuit, is a fluid or fluid mixture which has a pressure equal to or lower than R22. In some embodiments of a sensing element, the fluid suitable for use in the sensing element when R22 is used in the condenser-to-evaporator circuit, is a fluid or fluid mixture which has a slope of pressure/temperature relation that is substantially different from that of R22.

In one embodiment, the end of the sensing element that is communicatively coupled to the outlet side of the evaporator is a metallic bulb, which may be of any shape or volume, and the other end is a capillary tube. In some embodiments, the end of the sensing element end communicatively coupled to the outlet side of the evaporator is coupled to the evaporator outlet port. In other embodiments, the end of the sensing element coupled to the outlet side of the evaporator is communicatively coupled to the vapor refrigerant line (including either the vapor circuit line or the suction line).

In some embodiments, the sensing bulb is copper, a copper alloy or aluminum. In some embodiments, the sensing element is simply a line, which in some embodiments has a uniform diameter along its entire length and in other embodiments, is a line having a diameter that varies along its length.

The sensing element is of any length so as to communicate sufficient information about the temperature of vapor refrigerant (that is exiting from the evaporator) to the expansion valve. This length will vary from system to system and when two or more sensing elements are used in a multi-evaporator system, the length of each may be the same or different within each system.

In some embodiments, the sensing element is 3 feet in length or less (the sum of the length of any tube, line, pipe, conduit and combinations thereof). In some embodiments the sensing element is more than 3 feet length (the sum of the length of any tube, line, pipe, conduit and combinations thereof). In some embodiments, the sensing element is from 3 to 10 feet in length (the sum of the length of any tube, line, pipe, conduit and combinations thereof). In some embodiments the sensing element is more than 10 feet length (the sum of the length of any tube, line, pipe, conduit and combinations thereof). In some embodiments the sensing element is more than 15 feet length (the sum of the length of any tube, line, pipe, conduit and combinations thereof). In some embodiments the sensing element is more than 20 feet length (the sum of the length of any tube, line, pipe, conduit and combinations thereof).

In some embodiments, the sensing element is of sufficient diameter to effectively communicate with the TXV valve. In some embodiments, the diameter of the sensing element is no larger than ⅛ inch. In some embodiments, the diameter of the sensing element is larger than ⅛ inch. In other embodiments the sensing element is approximately 1/16 inch or narrower. In other embodiments the sensing element is larger than 1/16 inch. In other embodiments, the sensing element is approximately ¼ inch or narrower. In other embodiments, the sensing element is larger than ¼ inch.

Some embodiments are low temperature systems. In some embodiments, the system includes at least one evaporator operated at a target average temperature of about −25 degrees F. or lower. In some embodiments, the system includes at least one evaporator operated at a target average temperature of about −10 degrees F. or lower. In some embodiments, system includes at least one evaporator operated at a target average temperature of about 0 degrees F. or lower.

In some embodiments, the system has a target temperature to maintain the contents in a temperature controlled zone in a frozen state. In some embodiments, the systems are operated to maintain the temperature of the contents in a temperature controlled zone at about 0 degrees F. In some embodiments, the target temperature of the temperature controlled zones is below about −10 degrees F.

Some embodiments are Medium Temperature systems. In some embodiments, the systems include at least one evaporator operated at a target average temperature between about 0 degree F. and up to as high as about 40 degrees F. In some embodiments, at least one evaporator is operated at a target average temperature between about 0 and about +20 degrees F.

In some embodiments, the systems have a target temperature to maintain contents in a temperature controlled zones in a chilled, non-frozen state. In some embodiments, the target temperature for the contents in a temperature controlled zone is to be maintained at a temperature of from about +20 to about +45 degrees F. In some embodiments, the target temperature of a temperature controlled zone is between about +20 and about +40 degrees F.

In some embodiments, the temperature controlled zone of the system has a target temperature below about −10 degrees F. In some embodiments, the temperature controlled zone of the system has a target temperature of from about −10 to about +5 degrees F. In some embodiments, the target temperature of the temperature controlled zone is equal to or less than about 0 degrees F. In some embodiments, the temperature controlled zone of the system has a target temperature below between about −5 and +5 degrees F., excluding any defrost cycles. In some embodiments, the target temperature of the temperature controlled zone is equal to or less than about +32 degrees F.

In some embodiments, the target temperature of the temperature controlled zones is between about 0 and about +40 degrees F. In some embodiments, the target temperature of the temperature controlled zones is between about +10 and about +40 degrees F. In some embodiments, the temperature controlled zone of the system has a target temperature below between about +25 and +35 degrees F., excluding any defrost cycles.

In some embodiments, the temperature controlled zone of the system has a target temperature of from about +15 to about +45 degrees F. In some embodiments, the target temperature of the temperature controlled zone is equal to or less than about +20 degrees F.

In some embodiments, the systems are designed to undergo periodic defrost cycles. A defrost cycle is a short term warming of the evaporator. In some embodiments, the length of time depends on the size and condition of the evaporator undergoing defrost. In some embodiments, the defrost cycle is long enough to remove any ice deposited on the evaporator. For example, in some embodiments, the short term warming occurs over 60 minutes or shorter; and in other embodiments, the warming of can be as long as a few hours or more.

In some embodiments, the defrost cycle may not affect the temperature of the temperature controlled zones. In some embodiments, the defrost cycle may affect the temperature of the temperature controlled zones. In some embodiments the defrost cycle may not affect the temperature of the contents.

In some embodiments, air conditioning systems may be operated to achieve a temperature in the temperature control zone at typical room temperatures. In other embodiments, air conditioning systems may be operated to achieve a temperature in the temperature control zone at a temperature of from about 60 to about 80 degrees F. And, in some embodiments, air conditioning systems may be used to maintain the temperature controlled zone at a temperature having the need to be maintained at temperatures below about 60 degrees F.

In some embodiments, the system is operating as a heat pump system. In some embodiments, the heat pump system maintains the temperature controlled zone at a temperature above 60 degrees F. In some embodiments, the heat pump maintains the temperature controlled zone at a temperature above 70 degrees F.

In some embodiments, the systems are designed for a capacity of less than ¼ Ton. In some embodiments, the systems are designed for a capacity of less than ½ Ton. In some embodiments, the systems are designed for a capacity of less than 1 Ton. In some embodiments, the systems are designed for a capacity from about 1 to about 3 Tons. In some embodiments, the systems are designed for a capacity of from about 1 Ton to about 5 Tons. In some embodiments, the systems are designed for a capacity of greater than 5 Tons. In some embodiments, the systems are designed for a capacity of 8 Tons or greater than 8 Tons. In some embodiments, the systems are designed for a capacity of 10 Tons or greater than 10 Tons.

In some embodiments, the systems are designed for a capacity of 12 Tons or greater than 12 Tons. In some embodiments, the systems are designed for a capacity of 15 Tons or greater than 15 tons. In some embodiments, the systems are designed for a capacity of 20 Tons or greater than 20 tons. In some embodiments, the systems are designed for a capacity of 22 Tons or greater than 22 Tons. In some embodiments, the systems are designed for a capacity of greater than 25 Tons. In some embodiments, the systems are designed for a capacity of from 20 to 60 Tons. In some embodiments, the systems are designed for a capacity of greater than 60 Tons. In each of these systems, the total load may be reached by a variety of multi-sub systems having multiple temperature controlled zones with different target temperatures and different operating evaporator temperatures. In some embodiments, there may be more than one compressor and one or more condenser.

In some embodiments, the system includes a refrigerator, freezer or air conditioner or combinations thereof. In some embodiments, the system has one or more refrigerator temperature controlled zones and one or more freezer temperature controlled zones.

The tubes, lines, piping and conduits of the systems described herein can be made of any suitable material that can contain the refrigerants at the various temperatures and pressures without substantially altering the refrigerant, either chemically or physically. In some embodiments, the tubes, lines, piping and conduits can be made from the same materials or different materials. In some embodiments, the tube, line, piping and conduit materials are selected from the group consisting of glass, copper, copper alloy, aluminum, aluminum alloys, stainless steel and combinations thereof. In some embodiments having copper alloy, the copper alloy may further include molybdenum, nickel or mixtures thereof.

In some embodiments, the total length of tubes, lines, piping and conduits in the system is at least about 40 feet. In some embodiments, the total length of tubes, lines, piping and conduits is greater than 40 feet. In some embodiments, the total length of tubes, lines, piping and conduits is at least about 60 feet. In some embodiments, the total length of tubes, lines, piping and conduits is greater than 60 feet. In some embodiments, the total length of tubes, lines, piping and conduits is at least about 120 feet. In some embodiments, the total length of tubes, lines, piping and conduits is greater than 120 feet. In some embodiments, the total length of lines, piping and conduits is at least about 200 feet. In some embodiments, the total length of tubes, lines, piping and conduits is greater than 200 feet. In some embodiments, the total length of tubes, lines, piping and conduits is at least about 500 feet. In some embodiments, the total length of lines, piping and conduits is greater than 500 feet. In some embodiments, the total length of lines, piping and conduits is at least about 1,000 feet. In some embodiments, the total length of lines, piping and conduits is greater than 1,000 feet. In some embodiments, the total length of lines, piping and conduits is at least about 2,000 feet. In some embodiments, the total length of lines, piping and conduits is greater than 2,000 feet.

In some embodiments, the system has an average evaporator temperature selected from the temperature of between about −40 to about +40 degrees F. and a condenser temperature is in the range of between about +60 to +130 degrees F. In some embodiments, the system has an average evaporator temperature selected from the temperature of between about −40 to about +40 degrees F. and the condenser temperature is maintained in the range of from about +70 to about +105 degrees F.

In some embodiments, the system has an average evaporator temperature selected from the temperature between −20 and +20 degrees F. and a condenser temperature is maintained in the range of between about +60 to about +130 degrees F. In some embodiments, the system has an average evaporator temperature selected from the temperature between −20 and +20 degrees F. and a condenser temperature is maintained in the range of between about +70 to about +105 degrees F.

In some embodiments, the liquid refrigerant undergoes about 5 degrees F. of subcooling prior to reaching the expansion valve. In other embodiments, the liquid refrigerant undergoes between about 5 and about 10 degrees F. of subcooling prior to reaching the expansion valve. In other embodiments, the liquid refrigerant undergoes subcooling of between about 10 and about 20 degrees F. prior to reaching the expansion valve. In some embodiments, the liquid refrigerant undergoes more than 20 degrees F. of subcooling. In some embodiments, the liquid refrigerant undergoes no more than 50 degrees F. of subcooling. In some embodiments, the liquid refrigerant undergoes more than 50 degrees F. of subcooling.

In some embodiments, the system has at least two temperature controlled zones, at least two R22 expansion valves, and at least two evaporators. In some embodiments, the system has at least two temperature controlled zones, at least two R422D expansion valves, and at least two evaporators.

In some embodiment having two or more sensing elements, the two or more sensing elements contain R22. In some embodiments having two or more sensing elements, at least one sensing element contains R22 and at least one other sensing element contains a R422D composition.

In some embodiments, the systems may include 4 liquid circuit lines, 4 compressors, and 21 refrigerator and/or freezers cases and include more than 50 TXVs with distributors and 10 or more TXVs without distributors. In other embodiments, the systems may be low temperature refrigeration systems having from 9 to 15 liquid circuit lines, 15 to 42 freezer cases coupled to the system as various locations along the liquid circuit lines, including 1 or more walk-in freezer, and utilize from 4 to 6 compressors.

Some embodiments are Medium Temperature systems having 4 liquid circuit line, 21 refrigeration display cases as the temperature controlled zones, 4 compressors, and at least 60 TXV with distributors, and 10 TXVs without distributors. Some embodiments include only walk-in coolers, having at least 7 TXVs with distributors. Some Medium Temperature systems have 15 liquid circuit lines, having 42 cases (selected from the group consisting of refrigerators, freezers, chillers and combinations thereof), using 6 compressors, 34 TXVs with distributors, and 8 TXV without distributors. Some Medium Temperature systems use no distributors on the TXVs. Some Medium Temperature systems include 10 liquid circuit lines, having 18 refrigerator cases and 6 walk-in chiller cases, utilizing 4 compressors, and 18 TXV with distributors and 9 TXVs without distributors.

Some embodiments are Low Temperature systems including 9 liquid circuit lines, 28 freezer cases, 1 walk-in freezer, multiple compressors, 32 TXVs with distributors, and 1 TXV without a distributor. Some systems include 4 walk-in freezers using 5 TXVs with distributors.

In some embodiments, the system is rated to be operated at a load of at least 1000 BTUs/hour. In some embodiments, the system is rated to be operated at a load of more than 1,000 BTUs/hour. In some embodiments, the system is rated to be operated at a load of at least 50,000 BTUs/hour. In some embodiments, the system is rated to be operated at a load of at least 100,000 BTUs/hour. In some embodiments, the system is rated to be operated at a load of more than 100,000 BTUs/hour.

In some embodiments, no adjustment of the Superheat Adjustment Spring in the R22 Expansion Valve is required to accommodate a R422D composition in the condenser-to-evaporator circuit. In other embodiments, the Superheat Adjustment Spring is adjusted by no more than 3 psi (in either the positive or negative direction) to accommodate a R422D composition in the condenser-to-evaporator circuit. In some embodiments, the Superheat Adjustment Spring is adjusted by no more than 5 psi (in either the positive or negative direction) to accommodate a R422D composition in the condenser-to-evaporator circuit.

In systems using a R422D composition, other types of metering devices, other than a thermostatic expansion valves can be used. These systems include metering devices selected from the group comprising float type expansion valve, level control expansion valves, thermoelectric expansion valves, floatation-type expansion valves, level-type expansion valves, capillary tubes, and automatic expansion valves and combinations thereof.

### Method of Retrofitting Systems Previously Using Only R22

Further described is a method for retrofitting a heat transfer system having R22 in its condenser-to-evaporator circuit of the system, and having an R22 expansion valve, and having an R22 containing sensing element, said method comprising:
(i) removing R22 from the condenser-to-evaporator circuit of the system;
(ii) charging the condenser-to-evaporator circuit of the system with a replacement composition having a saturated vapor pressure that is substantially the same as that of R22, that has at least 90% of the cooling capacity of R22 under that same system operating conditions, and that does not increase the valve loading capacity beyond 130% of said R22 expansion valve.

In one embodiment, said method includes using a replacement refrigerant in step (ii) that has a zero ozone depletion potential. In one embodiment, said method includes using a replacement refrigerant in step (ii) that is non-flammable.

Global warming potentials (GWPs) are an index for estimating relative global warming contribution due to atmospheric emission of a kilogram of a particular greenhouse gas compared to emission of a kilogram of carbon dioxide over a time horizon of 100 years, as described in the Second Assessment Report (SAR-1995) of the Intergovernmental Panel on Climate Change.

In some embodiments, the replacement refrigerant has an acceptable global warming potential (“GWP”). In some embodiments, the global warming potential is lower than 2600. In some embodiments, the global warming potential is lower than 2300.

In one embodiment, the method includes using a R422D composition as the charging refrigerant of step (ii). In one embodiment, the method further includes replacing the R22 in the sensing element with the same refrigerant used in step (ii). In some embodiments, the method further includes replacing the R22 in the sensing element with a R422D composition.

In one embodiment, the method further comprising replacing all of the seals in the condenser-to-evaporator circuit of the system prior to the charging step (ii).

Seals in the condenser-to-evaporator circuit of the system are located in a variety of places in the system including the interfaces between two metal surfaces or fittings and other metal components, such as solenoid valves, Schraeder valves, ball valves, and the like, etc. The types of seals, can be as simple as an O-ring or a gasket and these are typically made of a wide variety of materials such as plastics, rubbers, and other elastomers. In some embodiments, these materials are Neoprene, Hydrogenated Nitrile Butadiene Rubber, NBR, ethylene Propylene Diene, EPDM, Silicone and mixtures and combination thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

### DETAILED DESCRIPTION OF THE DRAWINGS

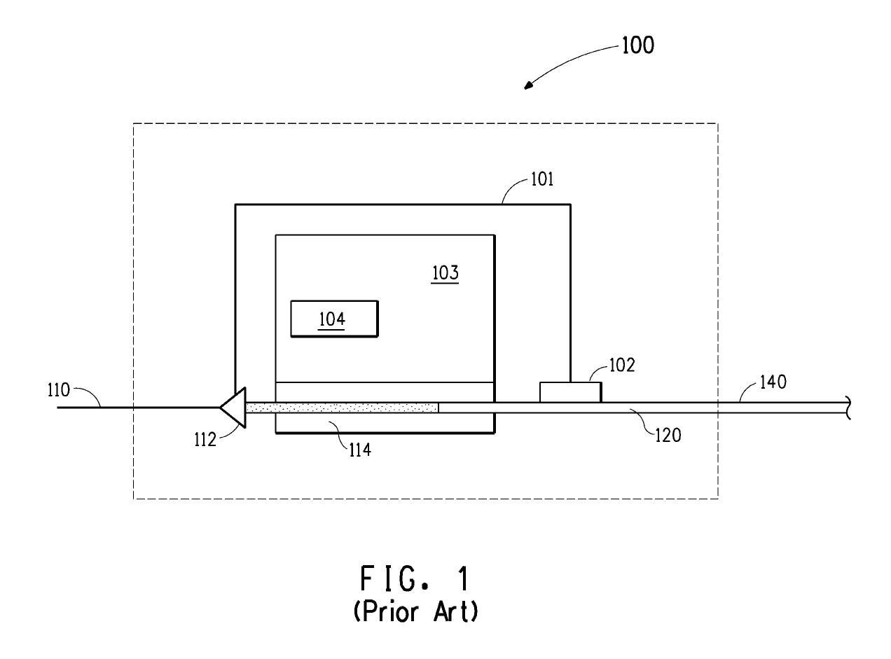

FIG. 1 is a schematic illustration of heat transfer system using R22 only (prior art). This schematic illustrates a system, 100, that uses only R22 in the sensing element, 101, and sensing bulb, 102. The temperature controlled zone to be cooled, is Cooling Zone, 103. The contents in the Cooling Zone are shown by Contents, 104. The liquid refrigerant line having R22, 110, enters the expansion valve, 112, and flows into the Evaporator, 114, where it expands, evaporates and exits the evaporator as a Superheated vapor, 120, in the Suction Line, 140. Any condensers and compressors of such a system are not shown.

In one embodiment described herein, such a system may undergo a retrofit whereby the R22 in the condenser-to-evaporator circuit is replace by a refrigerant composition (which in one embodiment is a R422D composition) having a saturated vapor pressure that is substantially the same as that of R22, that has at least 90% of the cooling capacity of R22 under that same system operating conditions, and the does not increase the valve loading capacity beyond 130% of said R22 expansion valve.

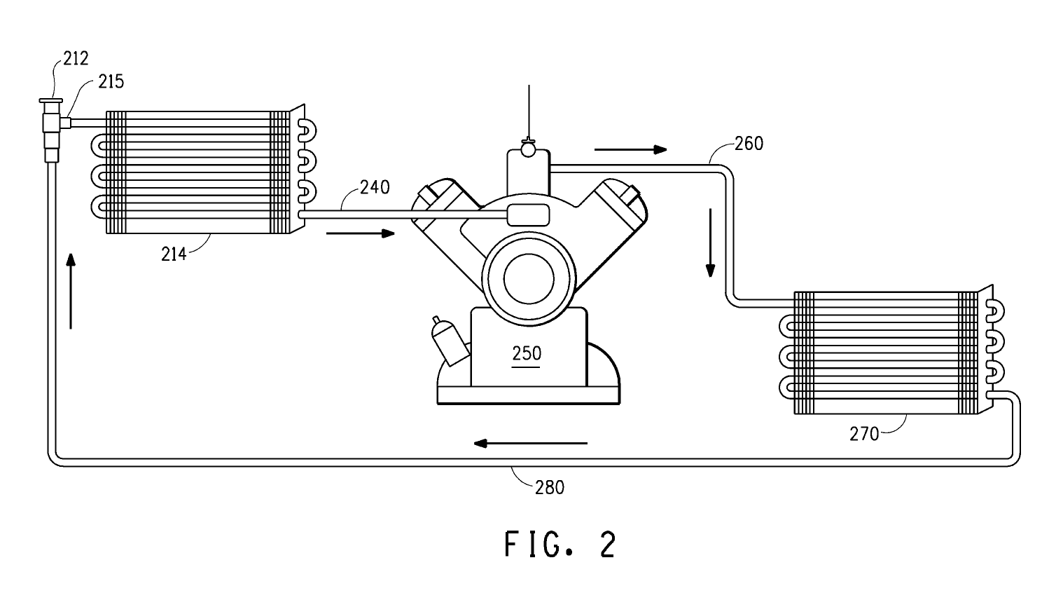

FIG. 2 is a schematic illustration of a refrigerant system having a thermostatic expansion valve. In this illustration, the system having the liquid refrigerant (either R22 as in the prior art or R422D for the embodiments described herein) moves the liquid refrigerant through the TXV, 212, whereby the refrigerant exits as a part-liquid and part-gas phase into the coupled Evaporator, 214, wherein the part-liquid and part-gas refrigerant moves into the Evaporator, exiting there from in the gas phase and entering into the Suction Line, 240. The gas phase refrigerant then moves onward to and into the coupled Compressor, 250, whereby it is compressed and returned to a hot gas state. The refrigerant then moves out of the Compressor into the coupled Hot Gas Line, 260, and then is moved onward and into to the Condenser, 270, whereby the gas refrigerant is condensed and returned to the liquid phase. The Liquid Refrigerant Line, 280, returns the liquid refrigerant to the TXV.

FIG. 3 is a schematic illustration of one type of expansion valve including the Valve Body, 92, coupled to a sensing element, 201, having a sensing bulb, 202, and liquid refrigerant inlet port, 97. The sensing bulb, 202, is part of the sensing element, 201, which is coupled to the thermostatic element, 99, having diaphragm, 84. In some embodiments, the diaphragm is replaced by a system of baffles (not shown). When the thermostatic element, 99, senses an increase in temperature in the sensing bulb, 202, P1 is exerted on the diaphragm pushing it downward (and in the embodiments of the systems described herein the sensing elements may contain R22 or R422D compositions) and pressure building up in the sensing capillary tube, 82, pushing against the push rod, 98, thereby pushing the Valve Plug, 96, away from the Valve Seat, 88, permitting liquid refrigerant to flow from the inlet port and to the evaporator (all while pushing against the Superheat Spring, 94). Some tuning of the TXV is permitted by the Superheat adjustment screw, 90, which can increase or decrease P₃. In some embodiments, the Superheat adjustment screw, 90, can be used to adjust P₃ by an amount of ±3 psi. In some embodiments, the Superheat adjustment screw, 90, can be used to adjust P₃ by an amount greater than ±3 psi. The part liquid-part gas refrigerant exits the Valve Body, 92, via the Outlet Port, 95. During operation of the system, the pressure exerted on the diaphragm (or baffles) is P1 (the Thermostatic Element's, 99, Vapor Pressure) and opposes the combined pressure P2 (the Evaporator pressure via Internal equalizer, 86,) and P3 (the pressure equivalent of the Superheat Adjustment Spring, 94, force).

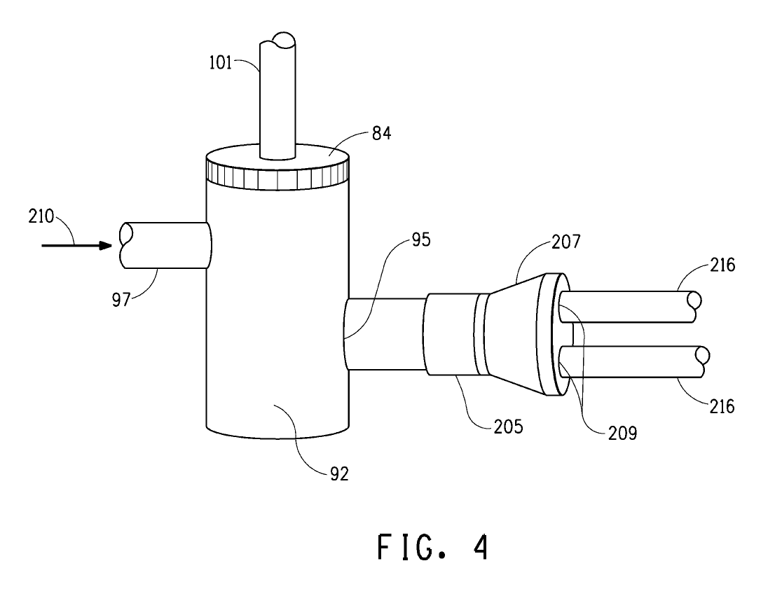

FIG. 4 is a schematic illustration of a thermostatic expansion valve having a nozzle and a distributor. Liquid Circuit Line, 210, in in fluid communication with the Inlet Port, 97, of the TXV Body, 92, having Diaphragm, 84, coupled to the sensing element, 101. TXV Body, 92, has Outlet Port, 95. In fluid communication with the Outlet Port, 95, is Nozzle, 205, which has Distributor, 207, in fluid communication therewith. Distributor, 207, has two Distributor Outlet Ports, 209, which are in fluid communication with the Evaporator, 214, having two Evaporator Coils, 216.

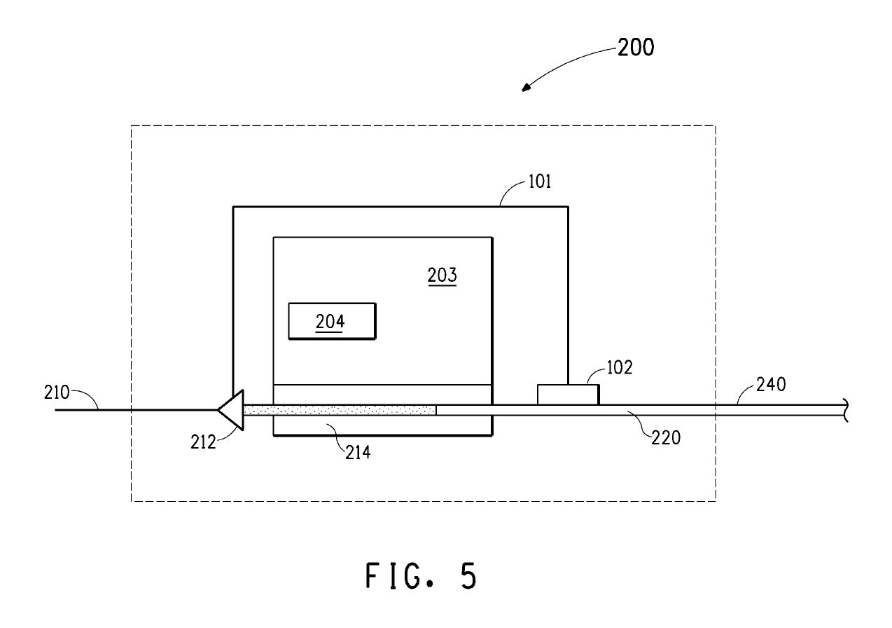

FIG. 5 is a schematic illustration of refrigerant system using R22 and one of the R422D compositions. This schematic illustrates a system, 200, that uses R22 in the sensing element, 101, and sensing bulb, 102. In this illustration, the area to be cooled, the temperature controlled zone, 203. The contents in the temperature controlled zone are shown by Contents, 204. The liquid refrigerant R422D, 210, enters the R22 Expansion Valve, 212, and flows into the Evaporator, 214, where it expands and evaporates and exits the evaporator as a Superheated vapor, 220, and Suction Line, 240. In some embodiments no adjustment of the R22 Expansion Valve is required to accommodate the R422D in the evaporator. The condenser and compressor of such a system are not shown.

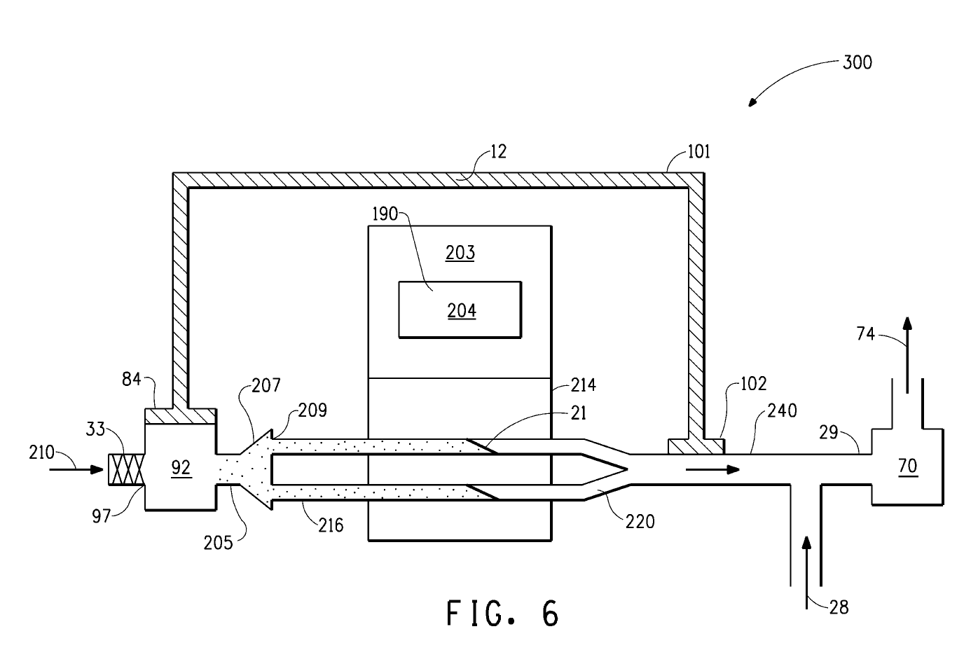

FIG. 6 is a schematic illustration of another embodiment, System 300, of one embodiment of the disclosed heat transfer system, a refrigerant system, using both R22 and R422D compositions. The liquid circuit line, 210, contains R422D, which enters the Valve Inlet Pipe, 33, into the Expansion Valve, 92, via the Valve Inlet Port, 97. The Expansion Valve, 92, includes Diaphragm, 84, coupled to the Sensing element, 101. The Expansion Valve has a Nozzle, 205, and Distributor, 207, coupled thereto. The Distributor, 207, has Distributor Outlet Ports, 209, in fluid communication with the Evaporator Coils, 216, where a portion of such coils is outside of the Evaporator, 214. The R422D is in two phases (liquid and gas) as it enters the Evaporator Coils, 216, reaches the saturated vapor condition as it exits the Evaporator, 214, and then undergoes superheating to become Superheated Vapor, 220. In some embodiments, the Superheat of the R422D is no more than 5 degrees F.; in some embodiments, the Superheat of the R422D is no more than 6 degrees F.; in some embodiments, the Superheat of the R422D is no more than 7 degrees F.; in other embodiments, the Superheat of the R422D is no more than 8 degrees F.; and in some embodiments, the superheat is no more than 10 degrees F.; in some embodiments, the Superheat of the R422D is maintained between 10 and 15 degrees F.; in other embodiments the Superheat of the R422D is no more than 15 degrees F.; and in other embodiments the Superheat of the R422D is no more than 20 degrees F. In some embodiments, the Superheat is maintained between 5 and 10 degrees F. superheat.

The Sensing bulb, 102, containing R22, senses the temperature of the Superheated R422D Vapor communicates via pressure of the R22 in the Sensing element, 101, which is coupled to Diaphragm, 84, in the Expansion Valve, 92, as necessary, to allow additional liquid to flow or restrict the flow of R422D to enter into the Expansion Valve, 92. Superheated Vapor, 220, moves into the Suction Line, 240, and then meets the Vapor Circuit Line, 28. Vapor Circuit Line, 28, is in fluid communication with other refrigeration systems, which may be the same or different as System 300. R422D vapor enters the Suction Header, 29, of the Compressor, 70. Compressor, 70, may be one or more compressor working together (e.g., a rack of Compressors, which may be the same type of compressors or different or may have same or different load capacities. After compressing the heated R422D vapor the gas exits the Compressor and moves into the Vapor Circuit Line, 74, to the Condenser (not shown. The R422D in the Evaporator has air passed over the Evaporator coils via a fan or other mechanism (not shown) in order to cool the air in the temperature Controlled Zone, 203, to the nominal desired temperature and cools Contents, 204, to the contents temperature, 190. The temperature of the Contents may be the same or different than that of the Temperature Controlled Zone. In some embodiments, no adjustment of the R22 Expansion Valve is required to accommodate the R422D in the evaporator.

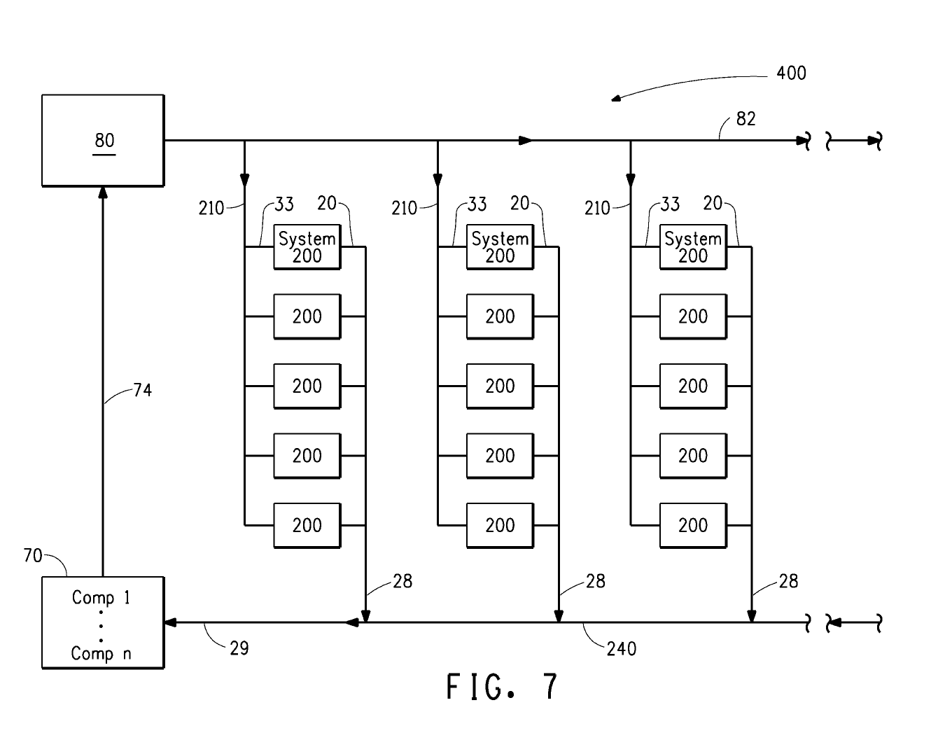

FIG. 7 is a schematic illustration of another embodiment of a refrigerant system, System 400, using R22 and R422D compositions in accordance one embodiment of the heat transfer system described herein. This system is a larger system than Systems 200 and 300, and is an illustration of 15 Systems 200 in fluid communication together and sharing a Liquid Refrigerant Trunk Line, 82, leading from Condenser, 80. Moreover, System 400 has 3 or more Liquid Refrigerant Circuit Lines, 210, each of which has at least 5 Systems 200 coupled thereto. Each System 200 has an Outlet Line, 20, which is in fluid communication with one of the multiple Vapor Circuit Line, 28, which in turn is in fluid communication with the Suction Line, 240. The Suction Line is in fluid communication with the Suction Header, 29, which is then in fluid communication with the Compressor, 70. Compressor, 70, may be a single compressor or may also be a rack of two or more Compressors working in parallel or in series. In some embodiments, the system can have at least 4 circuit lines, at least 4 compressors, with as many as 20 temperature controlled zones coupled thereto.

Each temperature controlled zones may be cooled by more than one evaporator each. In some systems, not all TXVs have distributors. And, in some systems, some TXVs will have distributors and others will not. In some embodiments no adjustment of the R22 Expansion Valve is required to accommodate the R422D in the evaporator.

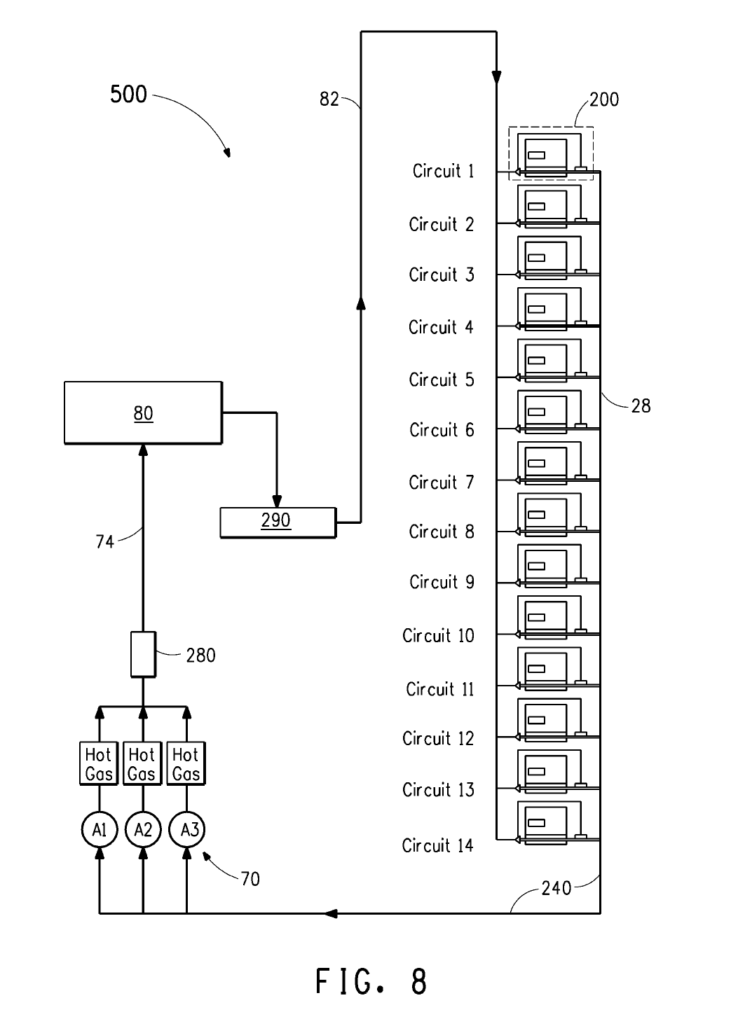

FIG. 8 is a schematic of the refrigeration system, for one embodiment of the refrigeration system described herein. This system illustrates the further use of an Oil Separator, 280, and a Receiver, 290. In some embodiments no adjustment of the R22 Expansion Valve is required to accommodate the R422D in the evaporator.

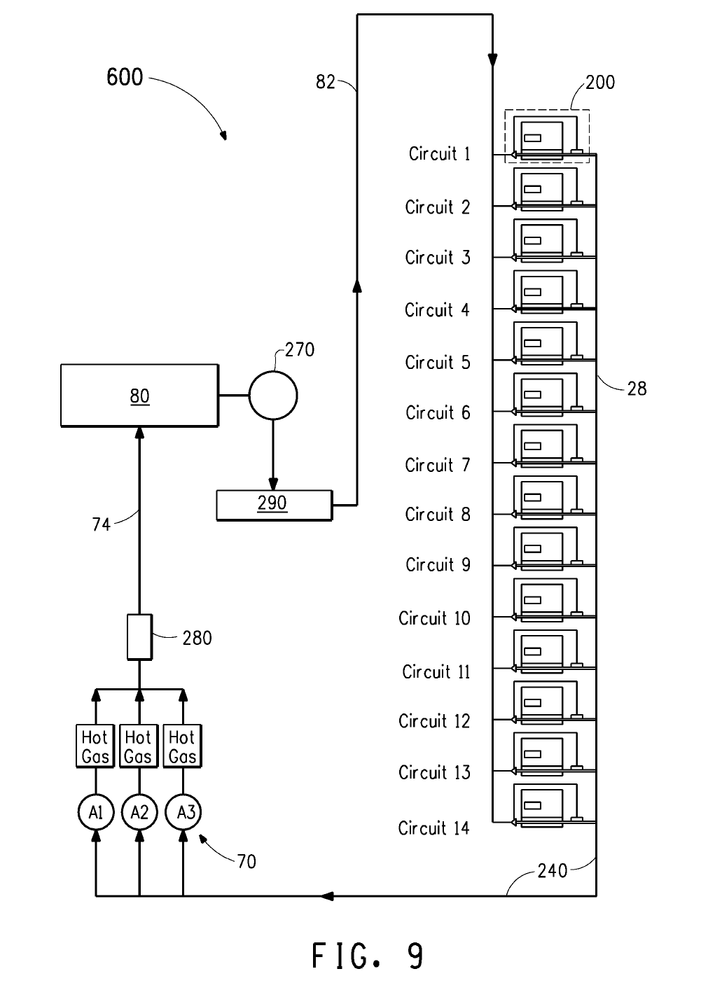

FIG. 9 is a schematic of the refrigeration system, for one embodiment of the refrigeration system described herein. This system illustrates the further use of a Subcooler, 270. In some embodiments no adjustment of the R22 Expansion Valve is required to accommodate the R422D in the evaporator.

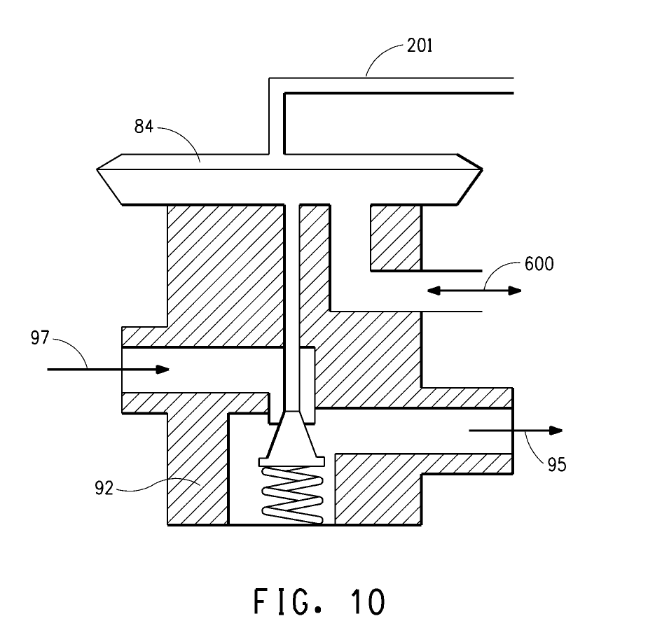

FIG. 10 is a schematic illustration of a external equalizer, 600, coupled to a thermostatic expansion valve. The external equalizer, 600, is connected to the evaporator outlet line, 20, (see FIG. 6). The evaporator pressure P₂ is conveyed to the bottom of the diaphragm, 84, via the external equalizer. For a better understanding of this embodiment, the external equalizer P₂ can be contrasted with internal equalizer, 86, (FIG. 3).

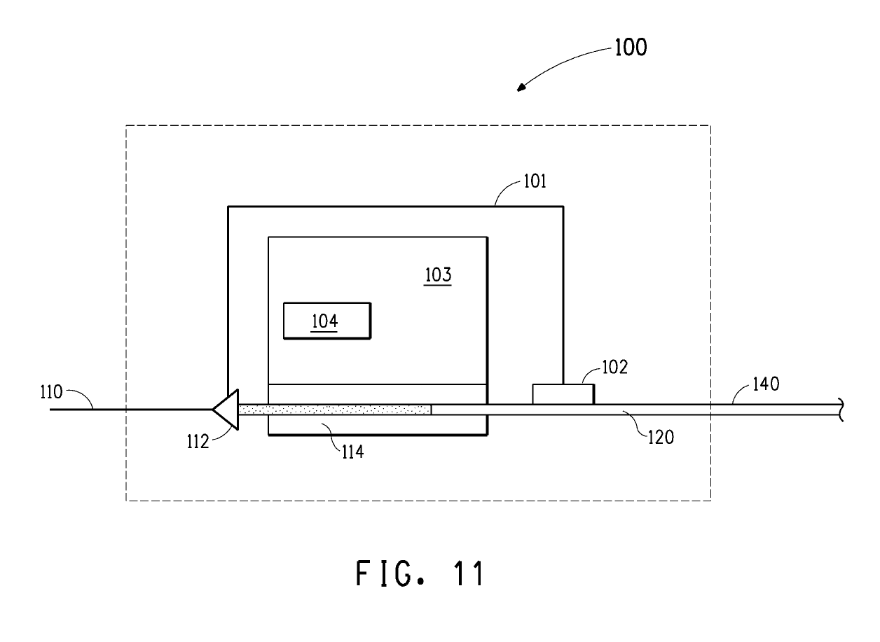

FIG. 11 is a schematic illustration of heat transfer system using a R422D composition only. This schematic illustrate system, 100, that uses only R422D in the sensing element, 101, and sensing bulb, 102. The temperature controlled zone to be cooled, is Cooling Zone, 103. The contents in the Cooling Zone is shown by Contents, 104. The liquid refrigerant line having R422D, 110, enters the expansion valve, 112, and flows into the Evaporator, 114, where it expands, evaporates and exits the evaporator as a Superheated vapor, 120, in the Suction Line, 140. Any condensers and compressors of such a system are not shown. The expansion valve, 112, may have been selected for R22 or R422D and may be an expansion valve previously used in a system using R22 in the condenser-to-evaporator circuit of the system. In some embodiments, using a R422D composition, a metering device other than expansive valve, 112, can be selected.

### EXAMPLES

The concepts described herein will be further described in the following examples, which do not limit the scope of the invention described in the claims.

### Example A

### Illustrative Data are from a Low Temperature, Multiple Temperature-Controlled Zones (“Cases”) System

The capacity of the system is rated to be able to handle a cooling capacity (load) of about 200,000 BTUs/hour.

The system has multiple evaporators, multiple TXVs, multiple distributors, multiple sensing elements, 14 vapor circuit lines, 14 liquid refrigerant circuit lines, at least one liquid trunk line, at least one suction line, 1 condenser (located outside under ambient conditions), at least five compressors, each having a power rating in the range of from 5 to 25 horse power. The sensing elements contained R22.

During days 1-11 the system was operated with R22 in both the sensing element and the condenser to evaporator circuit. The data below was from only a portion of the system. The 14 cases below were coupled to the system on over six separate liquid circuit lines (having 2, 1, 1, 4, 3, and 3 cases, respectively).

At Day 12, the R22 remained in the sensing element, the TXV was not changed, the Superheat Adjustment spring was not adjusted, and the R22 was removed from the condenser-to-evaporator circuits in the entire system and replaced by R422D. The system was then operated from Day 12-Day 16 with R422D in the condenser to evaporator circuit.

System A - Low Temp (° F.)

| | | Day | Day | Day | Day | Day | Day | Day | Day |
|---|---|---|---|---|---|---|---|---|---|
| | | 1 | 6 | 11 | 12 | 13 | 14 | 15 | 16 |
| | | Case | Case | Case | Case | Case | Case | Case | Case |
| | Case | Temp | Temp | Temp | Temp | Temp | Temp | Temp | Temp |
| Case | Target | (° F.) | (° F.) | (° F.) | (° F.) | (° F.) | (° F.) | (° F.) | (° F.) |
| 1 | −3 | 1 | 1 | 3 | 2 | 11* | 1 | −2 | 0 |
| 2 | −3 | 3 | 4 | 4 | 4 | 13* | 4 | −6 | −5 |
| 3 | −3 | −2 | 25* | −2 | 2 | 2 | 36* | 1 | 1 |
| 4 | −3 | −2 | −1 | −1 | 1 | 1 | 1 | 1 | 1 |
| 5 | −3 | −4 | −4 | −4 | 1 | −1 | −2 | −1 | −1 |
| 6 | −3 | −1 | 1 | 2 | 2 | 3 | 2 | 3 | 3 |
| 7 | −3 | 0 | −1 | 2 | 1 | 2 | 2 | 1 | 1 |
| 8 | −3 | 0 | 1 | 2 | 0 | 0 | 0 | −1 | 1 |
| 9 | −3 | 1 | −3 | −2 | 1 | 2 | 2 | 1 | 2 |
| 10 | −3 | −1 | −5 | −1 | −2 | −2 | −1 | −1 | −1 |
| 11 | −3 | 3 | −8 | −7 | 0 | 2 | 2 | 3 | 2 |
| 12 | −3 | −4 | −2 | −2 | −2 | 9* | 11* | −2 | −2 |
| 13 | −3 | −3 | −5 | 0 | 1 | 10* | 20* | 1 | 1 |
| 14 | −3 | −4 | −8 | −2 | 1 | 10* | 21* | 0 | −1 |

| | |
|---|---|
| Refrigerant R22 | Refrigerant R422D |

*During or immediately after a defrost cycle

System A - Low Temperature

| | Day 1 | Day 6 | Day 11 | Day 12 | Day 13 | Day 14 | Day 15 |
|---|---|---|---|---|---|---|---|
| Ambient Temp (° F.) | 58 | 67 | 62 | 59 | 67 | 78 | 71 |
| Condenser | 50% | 50% | | | | 50% | 100% |
| Receiver Level | 35% | 40% | 30% | 50% | 50% | 50% | 50% |
| Oil Level | 25% | 25% | 25% | 25% | 15% | 15% | 15% |
| Discharge Pressure (psig) | 200 | 210 | | 190 | 197 | 234 | 195 |
| Compressor Discharge Temp (° F.) | 188 | 180 | | | | | 172 |
| Discharge Temp Entering Condenser (° F.) | 127 | 128 | | | | | 148 |
| Suction Pressure (psig) | 9 | 9 | 9 | 10 | 8 | 10 | 10 |
| Suction Temp (° F.) | 38 | 38 | 37 | 33 | 32 | 35 | 33 |
| Rack Superheat (° F.) (vapor temperature | 59 | 59 | 58 | 49 | 52 | 51 | 51 |
| before entering the Compressor) | | | | | | | |
| Comp A-1 Hot Gas (° F.) | 193 | 194 | 191 | 109 | 187 | 188 | 182 |
| Comp A-2 Hot Gas (° F.) | 199 | 201 | 196 | 177 | 180 | 190 | 181 |
| Comp A-3 Hot Gas (° F.) | 196 | 196 | 194 | 179 | 184 | 188 | 184 |
| Comp A-4 Hot Gas (° F.) | 193 | 193 | 192 | 183 | 184 | 186 | 184 |
| Comp A-5 Hot Gas (° F.) | 194 | 194 | 193 | 190 | 185 | 187 | 185 |
| Liquid Return Pressure (psig) | 195 | 200 | | | | | 190 |
| Subcooler Temp (° F.) | 49 | 51 | 48 | 54 | 53 | 70 | 60 |
| Subcooler EPR (psig) | 80 | 80 | 80 | | | | 55 |
| Liquid Return Temp (° F.) | 60 | 68 | 64 | 79 | 83 | 98 | 81 |
| Pilot Valve (psig) | 95 | 95 | 95 | 95 | 95 | 95 | 95 |
| Hold Back Set (psig) | | | | 160 | 160 | 160 | 160 |
| Pressure Drop Across Oil Separator (psi) | 5 | 5 | 5 | 5 | 5 | 5 | 5 |
| Pressure Drop Across Subcooler (psi) | 5 | 5 | 5 | 5 | 5 | 5 | 5 |
| Pressure Drop Across Suction Filter (psi) | 0 | 0 | 0 | 0 | 0 | 0 | 0 |

| | |
|---|---|
| Refrigerant R22 | Refrigerant R422D |

Psig means pounds per square inch gauge.

### Example B

### Illustrative Data from a Low/Medium Temperature, Multiple Temperature-Controlled Zones (“Cases”) Split Rack System

The capacity of the system is rated to be able to handle a load of about 200,000 BTUs/hour.

The system has multiple evaporators, multiple TXVs, multiple distributors, multiple sensing elements, 12 vapor circuit lines, 12 liquid refrigerant circuit lines, at least one liquid trunk line, at least one suction line, 1 condenser (located outside under ambient conditions), and at least four compressors, each having a power rating in the range of from 5 to 25 horse power. In this split rack system (both low and medium temperature circuits operating in the same rack), evaporator pressure regulating (EPR) valves are used on individual circuits to maintain the desired circuit pressure in the evaporator. The sensing elements contained R22.

During days 1-6 the system was operated with R22 in both the sensing element and the condenser to evaporator circuit. The data below was from only a portion of the system, and includes both low and medium temperature cases. The 12 medium temperature cases in the first table below were coupled to the system on over three separate liquid circuit lines (having 6, 2, 4, and 1 cases, respectively). The 11 low temperature cases in the second table below were coupled to the system over four separate liquid circuit lines (having 1, 2, 6, and 2 cases, respectively).

At Day 13, the R22 remained in the sensing element, the TXV was not changed, the Superheat Adjustment spring was not adjusted, and the R22 was removed from the condenser-to-evaporator circuits in the entire system and replaced by R422D. The system was then operated from Day 13-Day 16 with R422D in the condenser to evaporator circuit.

d=defrost cycle

System B - Medium Temp

| | | | | | | | Day | |
|---|---|---|---|---|---|---|---|---|
| | | Day | Day | Day 13 | Day 13 | Day 14 | 15 | Day |
| | | 1 | 6 | AM | PM | AM | PM | 16 |
| | Case | Case | Case | Case | Case | Case | Case | Case |
| | Target | Temp | Temp | Temp | Temp | Temp | Temp | Temp |
| Case | (° F.) | (° F.) | (° F.) | (° F.) | (° F.) | (° F.) | (° F.) | (° F.) |
| 1 | 27 | 30 | 28 | 32 | 30 | 29 | 30 | 30 |
| 2 | 27 | 27 | 27 | 30 | 29 | 28 | 29 | 28 |
| 3 | 27 | 25 | 24 | 29 | 26 | 26 | 28 | 25 |
| 4 | 27 | 31 | 29 | 32 | 31 | 31 | 31 | 31 |
| 5 | 27 | 31 | 30 | 31 | 31 | 31 | 31 | 31 |
| 6 | 27 | 28 | 28 | 29 | 29 | 29 | 28 | 29 |
| 7 | 27 | 21 | 25 | 20 | 21 | 21 | 22 | 22 |
| 8 | 27 | 26 | 30 | 29 | 28 | 28 | 28 | 27 |
| 9 | 27 | 32 | 31 | 33 | 34 | 39d | 35 | 34 |
| 10 | 27 | 29 | 29 | 28 | 28 | 32d | 28 | 28 |
| 11 | 27 | 33 | 32 | 34 | 36 | 44d | 35 | 25 |
| 12 | 27 | 33 | 33 | 33 | 35 | 42d | 37 | 36 |

| | |
|---|---|
| Refrigerant | Refrigerant R422D |
| R22 | |

System B - Low Temp (° F.)

| | | | | | | | Day | |
|---|---|---|---|---|---|---|---|---|
| | | Day | Day | Day 13 | Day 13 | Day 14 | 15 | Day |
| | | 1 | 6 | AM | PM | AM | PM | 16 |
| | Case | Case | Case | Case | Case | Case | Case | Case |
| | Target | Temp | Temp | Temp | Temp | Temp | Temp | Temp |
| Case | (° F.) | (° F.) | (° F.) | (° F.) | (° F.) | (° F.) | (° F.) | (° F.) |
| 1 | −3 | −2 | −5 | −3 | −6 | −1 | | |
| 2 | −13 | −11 | −16 | −13 | −4 | −16 | | |
| 3 | −13 | −12 | −16 | −10 | −0 | −13 | | |
| 4 | −13 | −9 | −11 | −1 | −2 | −7 | | |
| 5 | −13 | −12 | −17 | −12 | −12 | −15 | | |
| 6 | −13 | −12 | −17 | −9 | −11 | −14 | | |
| 7 | −13 | −10 | −17 | −13 | −12 | −16 | | |
| 8 | −13 | −11 | −14 | −12 | −13 | −16 | | |
| 9 | −13 | −12 | −14 | −7 | −8 | −11 | | |
| 10 | −13 | −10 | −12 | −10 | −7 | −12 | | |
| 11 | −13 | −12 | −14 | −9 | −10 | −14 | | |

| | |
|---|---|
| Refrigerant | Refrigerant R422D |
| R22 | |

System B - Split Rack: Low & Medium Temp

| | Day | Day | Day | Day | Day | Day |
|---|---|---|---|---|---|---|
| | 1 | 6 | 13 | 13 | 15 | 16 |
| Ambient Temp (° F.) | 58 | 69 | 60 | 69 | 78 | 71 |
| Condenser (%) | 50% | 50% | | | | 100% |
| Receiver Level (%) | 40% | 25% | 50% | 60% | 50% | 50% |
| Oil Level (%) | 25% | 25% | 25% | | 25% | 25% |
| Discharge Pressure (psig) | 210 | 210 | 209 | 194 | 198 | 192 |
| Discharge Temp @ | 190 | 180 | | | | 170 |
| Compressor (° F.) | | | | | | |
| Discharge Temp Entering | 138 | 135 | | | | 147 |
| Condenser (° F.) | | | | | | |
| Suction Pressure | 10 | 8 | 9 | 8 | 6 | 7 |
| (psig) | | | | | | |
| Suction Temp (° F.) | 37 | 38 | 31 | 32 | 29 | 29 |
| Rack Superheat (° F.) | 57 | 62 | 49 | 52 | 52 | 52 |
| (vapor temperature | | | | | | |
| measured before entering | | | | | | |
| the compressor) | | | | | | |
| Comp B-1 Hot Gas (° F.) | 199 | 199 | 191 | 191 | 187 | 191 |
| Comp B-2 Hot Gas (° F.) | 196 | 196 | 192 | 190 | 189 | 190 |
| Comp B-3 Hot Gas (° F.) | 193 | 191 | 185 | 184 | 182 | 184 |
| Comp B-4 Hot Gas (° F.) | 208 | 178 | 192 | 193 | 192 | 193 |
| Liquid Return Pressure | 205 | 200 | | | | 195 |
| (psig) | | | | | | |
| Liquid Return Temp (° F.) | 96 | 93 | 77 | 77 | 98 | 90 |
| Subcooler Temp (° F.) | 58 | 56 | 61 | 58 | 70 | 60 |
| Subcooler EPR (psig) | 95 | 95 | | | | 62 |
| Pilot Valve (psig) | 75 | 75 | 75 | 75 | 75 | 75 |
| Hold Back Set (psig) | | | 160 | 160 | 160 | 160 |
| Pressure Drop Across Oil | 5 | 5 | 5 | 5 | 5 | 5 |
| Separator (psi) | | | | | | |
| Pressure Drop Across | 5 | 5 | 5 | 5 | 5 | 5 |
| Subcooler (psi) | | | | | | |
| Pressure Drop Across | 1 | 1 | 0 | 0 | 0 | 0 |
| Suction Filter (psi) | | | | | | |

| | |
|---|---|
| Refrigerant | Refrigerant R422D |
| R22 | |

Psig means pounds per square inch gauge.

### Example C

### Illustrative Data from a Medium Temperature, Multiple Temperature-Controlled Zones (“Cases”) System

The capacity of the system is rated to be able to handle a load of about 400,000 BTUs/hour.

The system has multiple evaporators, multiple TXVs, multiple distributors, multiple sensing elements, 9 vapor circuit lines, 9 liquid refrigerant circuit lines, at least one liquid trunk line, at least one suction line, 1 condenser (located outside under ambient conditions), and at least five compressors, each having a power rating in the range of from 5 to 25 horse power. The sensing elements contained R22.

During days 1-7 the system was operated with R22 in both the sensing element and the condenser to evaporator circuit. The data below was from only a portion of the system. The 10 cases below were coupled to the system on over five separate liquid circuit lines (having 3, 3, 1, 1, and 2 cases, respectively).

At Day 8, the R22 remained in the sensing element, the TXV was not changed, the Superheat Adjustment spring was not adjusted, and the R22 was removed from the condenser-to-evaporator circuits in the entire system and replaced by R422D. The system was then operated from Day 8-Day 16 with R422D in the condenser to evaporator circuit.

d=defrost cycle

System C Medium Temp (° F.)

| | | Day | Day | | Day 8 | Day 8 | Day | Day |
|---|---|---|---|---|---|---|---|---|
| | | 1 | 3 | Day 7 | AM | PM | 15 | 16 |
| | Case | Case | Case | Case | Case | Case | Case | Case |
| | Target | Temp | Temp | Temp | Temp | Temp | Temp | Temp |
| Case | (° F.) | (° F.) | (° F.) | (° F.) | (° F.) | (° F.) | (° F.) | (° F.) |
| 1 | 34 | 35 | 35 | 36 | 32 | 33 | 32 | 32 |
| 2 | 34 | 37 | 36 | 36 | 35 | 35 | 35 | 35 |
| 3 | 34 | 35 | 38 | 38 | 34 | 35 | 34 | 34 |
| 4 | 34 | 37 | 34 | 47d | 33 | 32 | 33 | 34 |
| 5 | 34 | 38 | 37 | 47d | 33 | 33 | 34 | 34 |
| 6 | 34 | 35 | 40 | 49d | 33 | 33 | 34 | 34 |
| 7 | 36 | 42 | 39 | 38 | 39 | 37 | 40 | 39 |
| 8 | 33 | 35 | 34 | 34 | 35 | 35 | 34 | 34 |
| 9 | 44 | 45 | 44 | 44 | 46 | 45 | 45 | 44 |
| 10 | 44 | 45 | 45 | 44 | 47 | 45 | 44 | 44 |

| | |
|---|---|
| Refrigerant R22 | Refrigerant R422D |

System C - Medium Temp

| | Day 1 | Day 3 | Day 7 | Day 8 | Day 15 | Day 16 |
|---|---|---|---|---|---|---|
| Ambient Temp (° F.) | 74 | 55 | 78 | 72 | 65 | 76 |
| Condenser (%) | 100% | 100% | 100% | 100% | | |
| Receiver Level (%) | 25% | 35% | 35% | 60% | 60% | 60% |
| Oil Level (%) | 50% | 50% | 50% | 60-70% | 25% | 60-70% |
| Discharge Pressure (psig) | 180 | 160 | 186 | 165 | 152 | 168 |
| Discharge Temp @ Compressor | 188 | 188 | 190 | 237 | | |
| (° F.) | | | | | | |
| Discharge Temp Entering | 176 | 175 | 168 | 132 | | |
| Condenser (° F.) | | | | | | |
| Suction Pressure (psig) | 38 | 33 | 31 | 35 | 35 | 34 |
| Suction Temp (° F.) | 58 | 49 | 52 | 48 | 49 | 47 |
| Rack Superheat (° F.)(vapor | 43 | 39 | 44 | 33 | 34 | 33 |
| temperature measured before | | | | | | |
| entering the compressor) | | | | | | |
| Comp C-1 Hot Gas (° F.) | | 193 | 202 | 153 | | |
| Comp C-2 Hot Gas (° F.) | | 187 | 182 | 140 | | |
| Comp C-3 Hot Gas (° F.) | | 198 | 152 | 138 | | |
| Comp C-4 Hot Gas (° F.) | | 197 | 197 | 146 | | |
| Comp C-5 Hot Gas (° F.) | | 206 | 162 | 144 | | |
| Liquid Return Pressure (psig) | 180 | 155 | 175 | 160 | | |
| Liquid Return Temp (° F.) | 82 | 79 | 86 | 81 | | |
| Pilot Valve (psig) | 110 | 110 | 110 | 110 | | |
| Pressure Drop Across Oil | 5 | 5 | 5 | 5 | | |
| Separator (psi) | | | | | | |
| Pressure Drop Across Subcooler | 5 | 5 | 5 | 0 | | |
| (psi) | | | | | | |
| Pressure Drop Across Suction | 0 | 0 | 0 | 2 | | |
| Filter (psi) | | | | | | |

| | |
|---|---|
| Refrigerant R22 | R422D |

Psig means pounds per square inch gauge.

1. A heat transfer system capable of being coupled to at least one temperature controlled zone, the elements of the system comprising:
(i) at least one liquid refrigerant line;
(ii) at least one expansion valve suitable for use with R22 or a R422D composition;
(iii) at least one evaporator;
(iv) at least one compressor;
(v) at least one condenser;
(vi) at least one vapor refrigerant line; and wherein all of the elements have an inlet side and an outlet side and elements (i) through (vi) are in fluid communication together and contain R422D; and the system further comprising at least one sensing element having two ends, wherein one end is communicatively coupled to the outlet side of at least one evaporator and the other end is communicatively coupled to at least one expansion valve and the at least one sensing element having a fluid suitable for use when R22 is in the condenser-to-evaporator circuit.

2. The system according to claim 1 wherein the at least one expansion valve is a thermostatic expansion valve

3. (canceled)

4. The system according to claim 1, wherein the fluid in the at least one sensing element is R22.

5. The system according to claim 1, wherein the fluid in the at least one sensing element is a fluid or fluid mixture selected to work when R22 is in the condenser-to-evaporator circuit, and having a pressure equal to or higher than R22.

6. The system according to claim 1, wherein the fluid in the at least one sensing element is a fluid or fluid mixture selected to work when R22 is in the condenser-to-evaporator circuit, and having a pressure equal to or lower than R22.

7. The system according to claim 1, wherein the fluid in the at least one sensing element is a fluid or fluid mixture selected to work when R22 is in the condenser-to-evaporator circuit, and having a slope of pressure/temperature relation that is substantially different from that of R22.

8. (canceled)

9. (canceled)

10. (canceled)

11. (canceled)

12. (canceled)

13. (canceled)

14. (canceled)

15. The system according to claim 1 wherein the system is selected to accommodate a temperature controlled zone coupled to devices selected from the group consisting refrigerators, deli cases, produce display cases, walk-in coolers, heat pumps, freezers, and air conditioners and combinations thereof.

16. (canceled)

17. (canceled)

18. (canceled)

19. (canceled)

20. (canceled)

21. (canceled)

22. The system according to claim 1, wherein the system comprises at least two temperature controlled zones, at least two expansion valves and at least two evaporators.

23. (canceled)

24. (canceled)

25. (canceled)

26. (canceled)

27. (canceled)

28. (canceled)

29. (canceled)

30. A refrigerator, walk-in cooler, chiller, produce display case, freezer or air-conditioner equipment, comprising at least one evaporator, at least one distributor and at least one R22 suitable expansion valve, and at least one R22 suitable sensing element, said improvement comprising having the sensing element containing a fluid or fluid mixture selected to work when R22 is in the condenser-to evaporator circuit, in combination with the use of a R422D composition refrigerant the condenser-to-evaporator circuit.

31. (canceled)

32. (canceled)

33. (canceled)

34. (canceled)

35. (canceled)

36. (canceled)

37. (canceled)

38. (canceled)

39. A refrigeration or an air conditioning system capable of being coupled to at least one temperature controlled zone, the elements of the system comprising:
(i) at least one liquid refrigerant line;
(ii) at least one metering device selected from the group consisting of thermostatic expansion valve, an electronic expansion valve, a capillary tube, float-type expansion valve, automatic expansion valve, and combinations thereof and selected for use with a R422D composition or R22;
(iii) at least one evaporator;
(iv) at least one compressor;
(v) at least one condenser;
(vi) at least one vapor refrigerant line; and wherein all of the elements have an inlet side and an outlet side and elements (i) through (vi) are in fluid communication together and contain R422D; and the system further comprising a sensing element having two ends, wherein one end is communicatively coupled to outlet side of the evaporator and the other end is communicatively coupled to at least one the expansion valve having R422D in the sensing element.

40. The system of claim 39, further comprising at least one thermostatic expansion valve selected for use with R22.

41. The system of claim 39, further comprising at least two thermostatic expansion valves and two sensing elements, and wherein at least one expansion valve was selected for use with R22 or R422D and one sensing element contains a fluid or fluid mixture selected to work when R22 is in the condenser-to-evaporator circuit, and at least one other sensing element contains a R422D composition.

42. (canceled)

43. (canceled)

44. (canceled)

45. (canceled)

46. (canceled)

47. (canceled)

48. (canceled)
